(19) United States
(12) Patent Application Publication
(10) Pub. No.: US 2024/0178964 A1
(43) Pub. Date: May 30, 2024

(54) TIME REVERSAL FOR ON-DEMAND POSITIONING

(71) Applicant: QUALCOMM Incorporated, San Diego, CA (US)

(72) Inventors: Weimin DUAN, San Diego, CA (US); Jing LEI, San Diego, CA (US); Alexandros MANOLAKOS, Escondido, CA (US)

(21) Appl. No.: 18/284,522

(22) PCT Filed: Mar. 15, 2022
(86) PCT No.: PCT/US2022/020417

§ 371 Date: Sep. 27, 2023

(30) Foreign Application Priority Data
May 5, 2021 (GR) 20210100299

(51) Int. Cl. H04L 5/00; H04B 7/06

(52) U.S. Cl. CPC H04L 5/0051; H04B 7/0626

(57) ABSTRACT

Methods and apparatus for on-demand transmission of time reversal (TR) precoded positioning signals are disclosed. In an example method, a user equipment (UE) may transmit a request for transmission of one or more positioning signals from a base station, the request associated with a TR precoding, transmit one or more signals to the base station, and receive from the base station the one or more positioning signals based at least in part on the transmitted request and the one or more transmitted signals.

### CROSS-REFERENCE TO RELATED APPLICATIONS

This application claims priority to and the benefit of Greek Application No. 20210100299, entitled “TIME REVERSAL FOR ON-DEMAND POSITIONING” filed May 5, 2021, which is assigned to the assignee hereof and which is expressly incorporated herein by reference in its entirety.

### TECHNICAL FIELD

Various aspects described herein generally relate to wireless communication systems, and more particularly, to applying a time-reversal filter to downlink positioning signals.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, and a fourth-generation (4G) service (e.g., Long Term Evolution (LTE) or WiMax). There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard (also referred to as “New Radio” (NR)), according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

One or more aspects may be directed to a user equipment (UE). The UE may include a transceiver, a memory, and a processor communicatively coupled to the transceiver and the memory. The processor may be configured to transmit a request for transmission of one or more positioning signals from a base station, the request associated with a time reversal (TR) precoding, transmit one or more signals to the base station, and receive, from the base station, the one or more positioning signals based at least in part on the transmitted request and the one or more transmitted signals.

One or more aspects may be directed to a method of a user equipment (UE).

The method may include transmitting a request for transmission of one or more positioning signals from a base station, the request associated with a time reversal (TR) precoding, transmitting one or more signals to the base station, and receiving, from the base station, the one or more positioning signals based at least in part on the transmitted request and the one or more transmitted signals.

One or more aspects may be directed to a user equipment (UE). The UE may include means for transmitting a request for transmission of one or more positioning signals from a base station, the request associated with a time reversal (TR) precoding, means for transmitting one or more signals to the base station, and means for receiving, from the base station, the one or more positioning signals based at least in part on the transmitted request and the one or more transmitted signals.

One or more aspects may also be directed to a base station. The base station may include a transceiver, a memory, and a processor communicatively coupled to the transceiver and the memory. The processor may be configured to receive a request for the transmission of one or more positioning signals from the base station to a UE, the request associated with a TR precoding, receive one or more signals from the UE, and transmit the one or more positioning signals to the UE based at least in part on the received request and the one or more received signals.

One or more aspects may also be directed a method of a base station. The method may include receiving a request for the transmission of one or more positioning signals from the base station to a UE, the request associated with a TR precoding, receiving one or more signals from the UE, and transmitting the one or more positioning signals to the UE based at least in part on the received request and the one or more received signals.

One or more aspects may also be directed a base station. The base station may include means for receiving a request for the transmission of one or more positioning signals from the base station to a UE, the request associated with a TR precoding, means for receiving one or more signals from the UE, and means for transmitting the one or more positioning signals to the UE based at least in part on the received request and the one or more received signals.

One or more aspects may also be directed to a location server. The network entity may include a transceiver, a memory, and a processor communicatively coupled to the transceiver and the memory. The processor may be configured to request transmission of one or more positioning signals from a base station to a UE, the one or more positioning signals associated with a TR precoding, receive one or more signals from the base station, the one or more signals associated with channel state information (CSI) from the UE, and transmit an indication to the base station, the indication associated with the TR precoding.

One or more aspects may be directed to a method of a location server. The method may include requesting transmission of one or more positioning signals from a base station to a UE, the one or more positioning signals associated with a TR precoding, receiving one or more signals from the base station, the one or more signals associated with channel state information (CSI) from the UE, and transmitting an indication to the base station, the indication associated with the TR precoding.

One or more aspects may be directed to a location server. The location server may include means for requesting transmission of one or more positioning signals from a base station to a UE, the one or more positioning signals associated with a TR precoding, means for receiving one or more signals from the base station, the one or more signals associated with channel state information (CSI) from the UE, and means for transmitting an indication to the base station, the indication associated with the TR precoding.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of the various aspects and embodiments described herein, and many attendant advantages thereof will be readily obtained as the same becomes better understood by reference to the following detailed description when considered in connection with the accompanying drawings which are presented solely for illustration and not limitation.

FIG. 1 illustrates an example wireless communications system, according to various aspects.

FIGS. 2A and 2B illustrate example wireless network structures, according to various aspects.

FIG. 3A illustrates an example base station and an example UE in an access network, according to various aspects.

FIG. 3B illustrates an example server, according to various aspects.

FIG. 3C shows a schematic block diagram illustrating certain example features of a UE, according to some implementations.

FIG. 3D shows a schematic block diagram illustrating certain example features of a base station, according to some implementations.

FIG. 4 illustrates an example wireless communications system, according to various aspects.

FIG. 5 illustrates an example wireless communications system, according to various aspects.

FIG. 6 illustrates a flowchart of an example method of a user equipment (UE) according to one or more aspects.

FIG. 7 illustrates a flowchart of an example method of a base station, according to one or more aspects.

FIG. 8 illustrates a flowchart of an example method of a location server, according to one or more aspects.

FIG. 9 illustrates a flowchart of an example method for generating a time reversal (TR) precoding, according to one or more aspects.

### DETAILED DESCRIPTION

Various aspects described herein generally relate to wireless communication systems, and more particularly, to enhance detectability of first path signal, e.g., for positioning, by applying a time-reversal filter to transmit positioning signals. These and other aspects are disclosed in the following description and related drawings to show specific examples relating to example aspects. Alternate aspects will be apparent to those skilled in the pertinent art upon reading this disclosure and may be constructed and practiced without departing from the scope or spirit of the disclosure. Additionally, well-known elements will not be described in detail or may be omitted so as to not obscure the relevant details of the aspects disclosed herein.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage, or mode of operation.

The terminology used herein describes particular aspects only and should not be construed to limit any aspects disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

As used herein, the terms “user equipment” (or “UE”), “user device,” “user terminal,” “client device,” “communication device,” “wireless device,” “wireless communications device,” “handheld device,” “mobile device,” “mobile terminal,” “mobile station,” “handset,” “access terminal,” “subscriber device,” “subscriber terminal,” “subscriber station,” “terminal,” and variants thereof may interchangeably refer to any suitable mobile or stationary device that can receive wireless communication and/or navigation signals. These terms are also intended to include devices which communicate with another device that can receive wireless communication and/or navigation signals such as by short-range wireless, infrared, wireline connection, or other connection, regardless of whether satellite signal reception, assistance data reception, and/or position-related processing occurs at the device or at the other device. In addition, these terms are intended to include all devices, including wireless and wireline communication devices, that can communicate with a core network via a radio access network (RAN), and through the core network the UEs can be connected with external networks such as the Internet and with other UEs. Of course, other mechanisms of connecting to the core network and/or the Internet are also possible for the UEs, such as over a wired access network, a wireless local area network (WLAN) (e.g., based on IEEE 802.11, etc.) and so on. UEs can be embodied by any of a number of types of devices including but not limited to printed circuit (PC) cards, compact flash devices, external or internal modems, wireless or wireline phones, smartphones, tablets, tracking devices, asset tags, smart watches and other wearable devices, servers, routers, electronic devices implemented in vehicles (e.g., automobiles, bicycles, motorcycles, etc.) and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

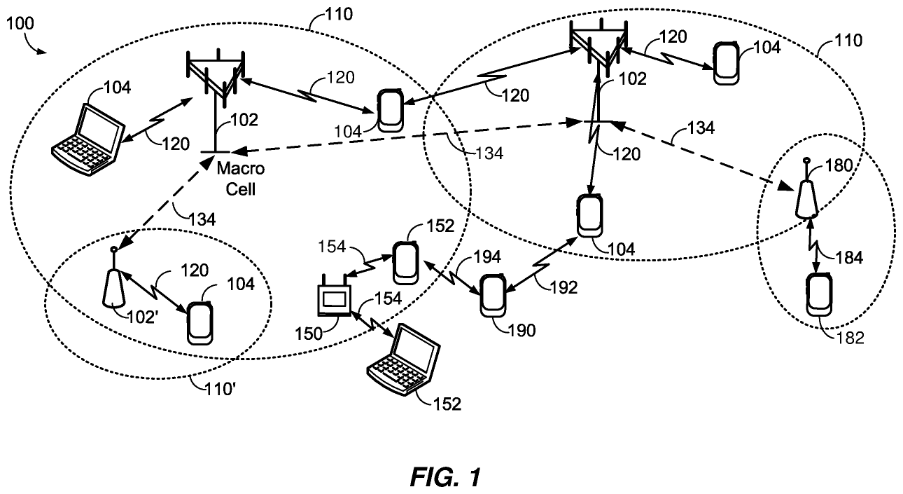

According to various aspects, FIG. 1 illustrates an example wireless communications system 100. The wireless communications system 100, which may also be referred to as a wireless wide area network (WWAN), may include various base stations 102 and various UEs 104. The base stations 102 may include macro cells (high power cellular base stations) and/or small cells (low power cellular base stations). The macro cells may include Evolved NodeBs (eNBs), where the wireless communications system 100 corresponds to an LTE network, gNodeBs (gNBs), where the wireless communications system 100 corresponds to a 5G NR network, and/or a combination thereof, and the small cells may include femtocells, picocells, microcells, etc.

The base stations 102 may collectively form a Radio Access Network (RAN) and interface with an Evolved Packet Core (EPC), Next Generation Core (NGC), or 5G Core (5GC) through backhaul links. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, delivery of warning messages, and the like. The base stations 102 may communicate with each other directly or indirectly (e.g., through the EPC/NGC/5GC) over backhaul links 134, which may be wired or wireless.

The base stations 102 may wirelessly communicate with the UEs 104. Each of the base stations 102 may provide communication coverage for a respective geographic coverage area 110. In an aspect, although not shown in FIG. 1, geographic coverage areas 110 may be subdivided into a plurality of cells (e.g., three), or sectors, each cell corresponding to a single antenna or array of antennas of a base station 102. As used herein, the term “cell” or “sector” may correspond to one of a plurality of cells of a base station 102, or to the base station 102 itself, depending on the context.

While neighboring macro cell geographic coverage areas 110 may partially overlap (e.g., in a handover region), some of the geographic coverage areas 110 may be substantially overlapped by a larger geographic coverage area 110. For example, a small cell base station 102′ may have a geographic coverage area 110′ that substantially overlaps with the geographic coverage area 110 of one or more macro cell base stations 102. A network that includes both small cell and macro cells may be known as a heterogeneous network. A heterogeneous network may also include Home eNBs (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links may be through one or more carriers. Allocation of carriers may be asymmetric with respect to DL and UL (e.g., more, or less carriers may be allocated for DL than for UL).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) prior to communicating in order to determine whether the channel is available. Although FIG. 1 illustrates specific STAs 152, in an aspect, any of UEs 104 may be capable of communicating with WLAN AP 150 and may therefore be referred to as a WLAN station (STA).

The small cell base station 102′ may operate in a licensed and/or an unlicensed frequency spectrum. When operating in an unlicensed frequency spectrum, the small cell base station 102′ may employ LTE or 5G technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. LTE in an unlicensed spectrum may be referred to as LTE-unlicensed (LTE-U), licensed assisted access (LAA), or MulteFire.

The wireless communications system 100 may further include a mmW base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 may utilize beamforming 184 with the UE 182 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

The wireless communications system 100 may further include one or more UEs, such as UE 190, that connects indirectly to one or more communication networks via one or more device-to-device (D2D) peer-to-peer (P2P) links. In the embodiment of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192-194 may be supported with any well-known D2D radio access technology (RAT), such as LTE Direct (LTE-D), WiFi Direct (WiFi-D), Bluetooth, and so on.

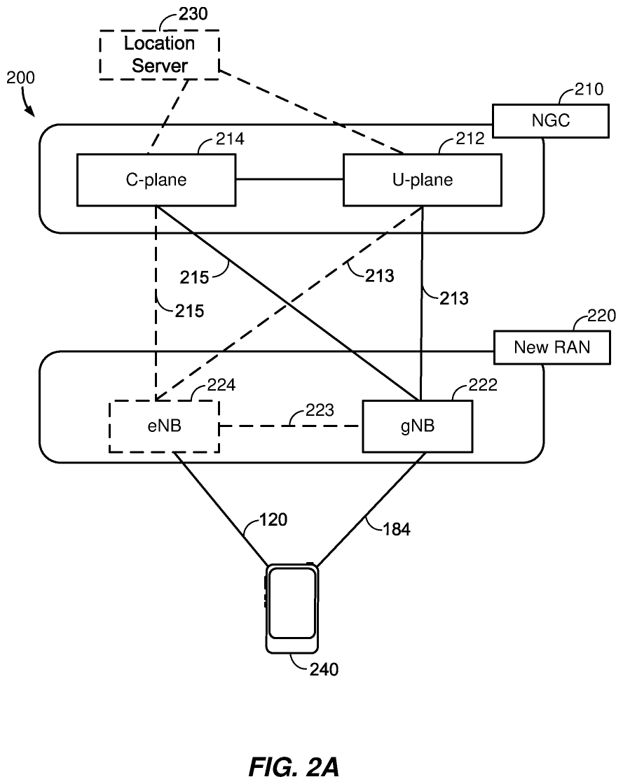

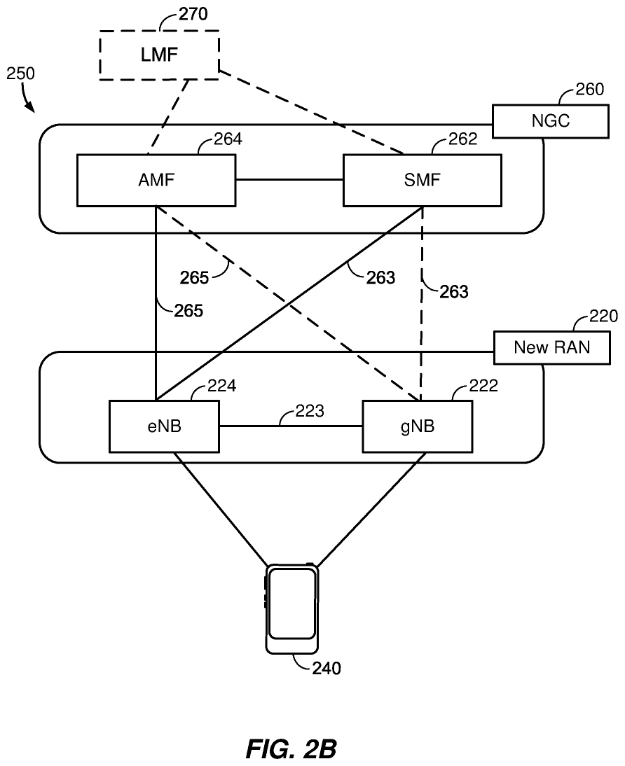

According to various aspects, FIG. 2A illustrates an example wireless network structure 200. For example, a Next Generation Core (NGC) 210 can be viewed functionally as control plane functions 214 (e.g., UE registration, authentication, network access, gateway selection, etc.) and user plane functions 212, (e.g., UE gateway function, access to data networks, IP routing, etc.) which operate cooperatively to form the core network. User plane interface (NG-U) 213 and control plane interface (NG-C) 215 may connect the gNB 222 to the NGC 210 and specifically to the control plane functions 214 and user plane functions 212. In an additional configuration, an eNB 224 may also be connected to the NGC 210 via NG-C 215 to the control plane functions 214 and NG-U 213 to user plane functions 212. Further, eNB 224 may directly communicate with gNB 222 via a backhaul connection 223. Accordingly, in some configurations, the New RAN 220 may only have one or more gNBs 222, while other configurations include one or more of both eNBs 224 and gNBs 222. Either gNB 222 or eNB 224 may communicate with UEs 240 (e.g., any of the UEs depicted in FIG. 1, such as UEs 104, UE 182, UE 190, etc.). Another optional aspect may include Location Server 230 which may be in communication with the NGC 210 to provide location assistance for UEs 240. The location server 230 can be implemented as a plurality of structurally separate servers, or alternately may each correspond to a single server. The location server 230 can be configured to support one or more location services for UEs 240 that can connect to the location server 230 via the core network, NGC 210, and/or via the Internet (not illustrated). Further, the location server 230 may be integrated into a component of the core network, or alternatively may be external to the core network.

According to various aspects, FIG. 2B illustrates another example wireless network structure 250. For example, an NGC 260 can be viewed functionally as control plane functions, an access and mobility management function (AMF) 264 and user plane functions, and a session management function (SMF) 262, which operate cooperatively to form the core network. User plane interface 263 and control plane interface 265 may connect the eNB 224 to the NGC 260 and specifically to AMF 264 and SMF 262. In an additional configuration, a gNB 222 may also be connected to the NGC 260 via control plane interface 265 to AMF 264 and user plane interface 263 to SMF 262. Further, eNB 224 may directly communicate with gNB 222 via the backhaul connection 223, with or without gNB direct connectivity to the NGC 260. Accordingly, in some configurations, the New RAN 220 may only have one or more gNBs 222, while other configurations include one or more of both eNBs 224 and gNBs 222. Either gNB 222 or eNB 224 may communicate with UEs 204 (e.g., any of the UEs depicted in FIG. 1, such as UEs 104, UE 182, UE 190, etc.). Another optional aspect may include a location management function (LMF) 270, which may be in communication with the NGC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, NGC 260, and/or via the Internet (not illustrated).

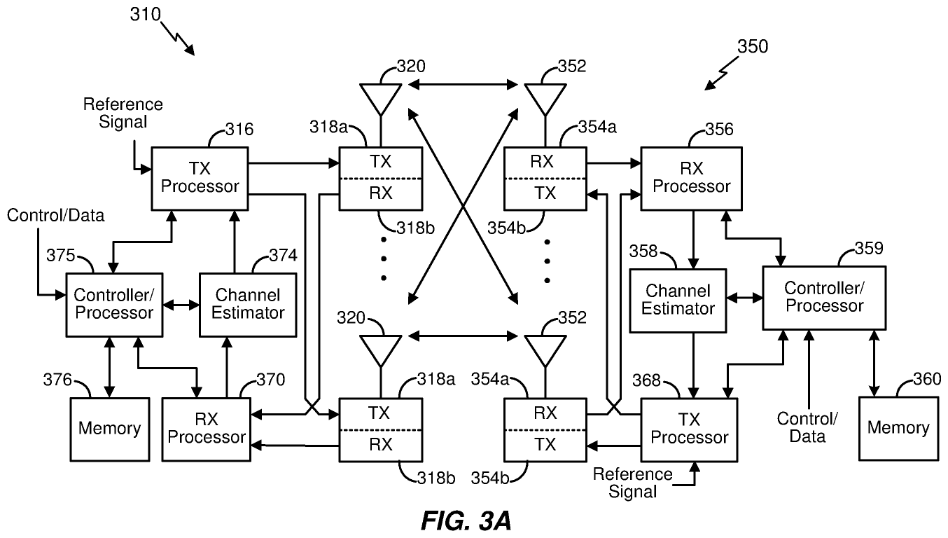

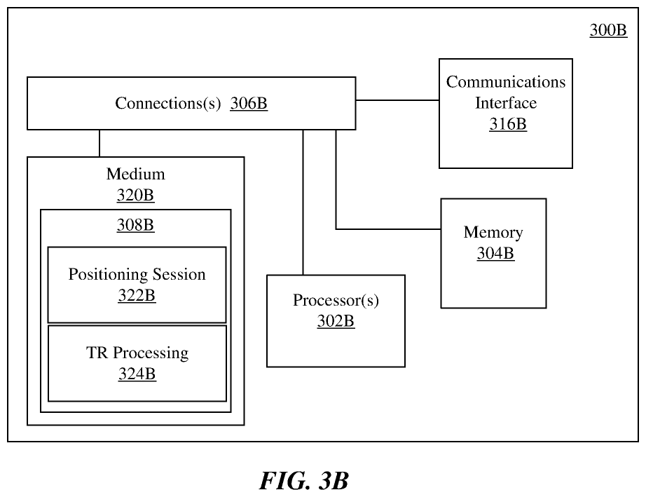

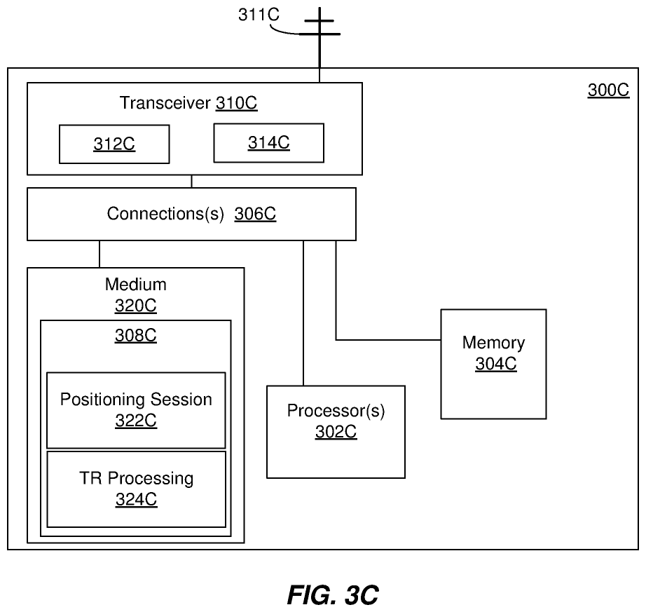

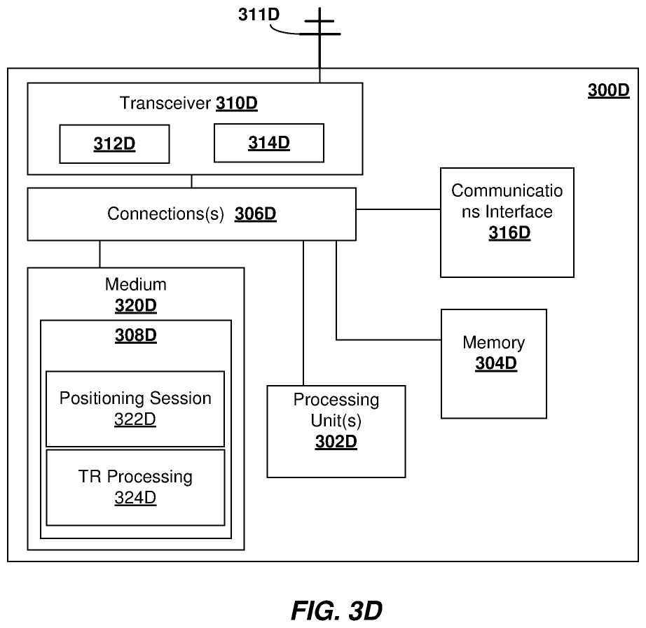

According to various aspects, FIG. 3A illustrates an example base station 310 (e.g., an eNB, a gNB, a small cell AP, a WLAN AP, etc.) in communication with an example UE 350 in a wireless network. In the DL, IP packets from the core network (NGC 210/EPC 260) may be provided to a controller/processor 375. The controller/processor 375 may implement functionality for a radio resource control (RRC) layer, a packet data convergence protocol (PDCP) layer, a radio link control (RLC) layer, and a medium access control (MAC) layer. The controller/processor 375 may provide RRC layer functionality associated with broadcasting of system information (e.g., MIB, SIBs), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmit (TX) processor 316 and the receive (RX) processor 370 may implement Layer-1 functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 may handle mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream may be spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to one or more different antennas 320 via a separate transmitter 318a. Each transmitter 318a may modulate an RF carrier with a respective spatial stream for transmission.

At the UE 350, each receiver 354a may receive a signal through its respective antenna 352. Each receiver 354a may recover information modulated onto an RF carrier and provides the information to the RX processor 356. The TX processor 368 and the RX processor 356 may implement Layer-1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 may then convert the OFDM symbol stream from the time-domain to the frequency domain using a Fast Fourier Transform (FFT). The frequency domain signal may comprise a separate OFDM symbol stream for each subcarrier of the OFDM signal. The symbols on each subcarrier, and the reference signal, may be recovered and demodulated by determining the most likely signal constellation points transmitted by the base station 310. These soft decisions may be based on channel estimates computed by the channel estimator 358. The soft decisions may then be decoded and de-interleaved to recover the data and control signals that were originally transmitted by the base station 310 on the physical channel. The data and control signals may then be provided to the controller/processor 359, which implements Layer-3 and Layer-2 functionality.

The controller/processor 359 can be associated with a memory 360 that stores program codes and data. The memory 360 may be referred to as a computer-readable medium. In the UL, the controller/processor 359 may provide demultiplexing between transport and logical channels, packet reassembly, deciphering, header decompression, and control signal processing to recover IP packets from the core network. The controller/processor 359 may also be responsible for error detection.

Similar to the functionality described in connection with the DL transmission by the base station 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354b. Each transmitter 354b may modulate an RF carrier with a respective spatial stream for transmission.

The UL transmission may be processed at the base station 310 in a manner similar to that described in connection with the receiver function at the UE 350. Each receiver 318b may receive a signal through its respective antenna 320. Each receiver 318b may recover information modulated onto an RF carrier and provide the information to a RX processor 370.

The controller/processor 375 can be associated with a memory 376 that stores program codes and data. The memory 376 may be referred to as a computer-readable medium. In the UL, the controller/processor 375 may provide demultiplexing between transport and logical channels, packet reassembly, deciphering, header decompression, control signal processing to recover IP packets from the UE 350. IP packets from the controller/processor 375 may be provided to the core network. The controller/processor 375 is also responsible for error detection.

Regarding the base station 310, a combination of transmitter 318a and receiver 318b may be referred to as a transceiver 318. The transmitter 318a and the receiver 318b that make up the transceiver 318 may be separate components dedicated for transmitting and receiving. Alternatively, the transmitter 318a and the receiver 318b may be integrated into the transceiver 318. The transceiver 318 may be wireless (e.g., for communication with the UE 350 and/or with other network nodes (e.g., base stations, LMF, etc.)), or wired (e.g., for communication with other network nodes).

Regarding the UE 350, a combination of transmitter 354a and receiver 354b may be referred to as a transceiver 354. The transmitter 354a and the receiver 354b that make up the transceiver 354 may be separate components dedicated for transmitting and receiving. Alternatively, the transmitter 354a and the receiver 354b may be integrated into the transceiver 354. The transceiver 354 may be wireless (e.g., for communication with the base station 310).

FIG. 3B illustrates an example server 300B, according to an aspect. In an example, the server 300B may correspond to an example configuration of the location server 230 or the LMF 270 described above. The location server 300B may be, e.g., a E-SMLC or LMF. The location server 300B may perform the process flow shown in FIG. 14. Location server 300B may, for example, include one or more processors 302B, memory 304B, and an external interface 316B (e.g., wireline or wireless network interface to other network entities, such as core network entities and base stations), which may be operatively coupled with one or more connections 306B (e.g., buses, lines, fibers, links, etc.) to non-transitory computer readable medium 320B and memory 304B. The base station 300B may further include additional items, which are not shown, such as a user interface that may include e.g., a display, a keypad or other input device, such as virtual keypad on the display, through which a user may interface with the location server. In certain example implementations, all or part of location server 300B may take the form of a chipset, and/or the like. The external interface 316B may be a wired or wireless interface capable of connecting to base stations in the RAN or network entities, such as an AMF or MME.

The one or more processors 302B may be implemented using a combination of hardware, firmware, and software. For example, the one or more processors 302B may be configured to perform the functions discussed herein by implementing one or more instructions or program code 308B on a non-transitory computer readable medium, such as medium 320B and/or memory 304B. In some embodiments, the one or more processors 302B may represent one or more circuits configurable to perform at least a portion of a data signal computing procedure or process related to the operation of location server 300B.

The medium 320B and/or memory 304B may store instructions or program code 308B that contain executable code or software instructions that when executed by the one or more processors 302B cause the one or more processors 302B to operate as a special purpose computer programmed to perform the techniques disclosed herein. As illustrated in location server 300B, the medium 320B and/or memory 304B may include one or more components or modules that may be implemented by the one or more processors 302B to perform the methodologies described herein. While the components or modules are illustrated as software in medium 320B that is executable by the one or more processors 302B, it should be understood that the components or modules may be stored in memory 304B or may be dedicated hardware either in the one or more processors 302B or off the processors. A number of software modules and data tables may reside in the medium 320B and/or memory 304B and be utilized by the one or more processors 302B in order to manage both communications and the functionality described herein. It should be appreciated that the organization of the contents of the medium 320B and/or memory 304B as shown in location server 300B is merely exemplary, and as such the functionality of the modules and/or data structures may be combined, separated, and/or be structured in different ways depending upon the implementation of the location server 300B.

The medium 320B and/or memory 304B may include a positioning session module 322B that when implemented by the one or more processors 302B configures the one or more processors 302B to engage in a positioning session for the UE. For example, the one or more processors 302B may be configured to engage in a positioning session by requesting and receive positioning capabilities from a UE, via the external interface 316B. The one or more processors 302B may be configured to generate and send positioning assistance data to the UE and/or serving base station, via the external interface 316B. The one or more processors 302B may further be configured to receive a measurement information report, via the external interface 316B, from the UE. The one or more processors 302B may further be configured to determine a position location for the UE based on the positioning measurements received in the measurement information report.

The medium 320B and/or memory 304B may include a TR processing module 324B that when implemented by the one or more processors 302B configures the one or more processors 302B to enable one or more positioning signals to be filtered according to a TR precoding. For example, the one or more processors 302B may be configured to request one or more positioning signals associated with a TR precoding to be transmitted from a base station to a UE. The one or more processors 302B may be configured to receive one or more signals from the base station which are associated with channel state information (CST) from the UE. The one or more processors 302B may further be configured to transmit, to the base station, an indication associated with the TR precoding.

The methodologies described herein may be implemented by various means depending upon the application. For example, these methodologies may be implemented in hardware, firmware, software, or any combination thereof. For a hardware implementation, the one or more processors 302B may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 320B or memory 304B that is connected to and executed by the one or more processors 302B. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 308B on a non-transitory computer readable medium, such as medium 320B and/or memory 304B. Examples include computer readable media encoded with a data structure and computer readable media encoded with a computer program 308B. For example, the non-transitory computer readable medium including program code 308B stored thereon may include program code 308B to support positioning of the UE using non-PRS signals for positioning measurements in a manner consistent with disclosed embodiments. Non-transitory computer readable medium 320B includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 308B in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers.

Combinations of the above should also be included within the scope of computer readable media.

In addition to storage on computer readable medium 320B, instructions and/or data may be provided as signals on transmission media included in a communication apparatus. For example, a communication apparatus may include an external interface 316B having signals indicative of instructions and data. The instructions and data are configured to cause one or more processors to implement the functions outlined in the claims. That is, the communication apparatus includes transmission media with signals indicative of information to perform disclosed functions.

Memory 304B may represent any data storage mechanism. Memory 304B may include, for example, a primary memory and/or a secondary memory. Primary memory may include, for example, a random access memory, read only memory, etc. While illustrated in this example as being separate from one or more processors 302B, it should be understood that all or part of a primary memory may be provided within or otherwise co-located/coupled with the one or more processors 302B. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 320B. As such, in certain example implementations, the methods and/or apparatuses presented herein may take the form in whole or part of a computer readable medium 320B that may include computer implementable code 308B stored thereon, which if executed by one or more processors 302B may be operatively enabled to perform all or portions of the example operations as described herein. Computer readable medium 320B may be a part of memory 304B.

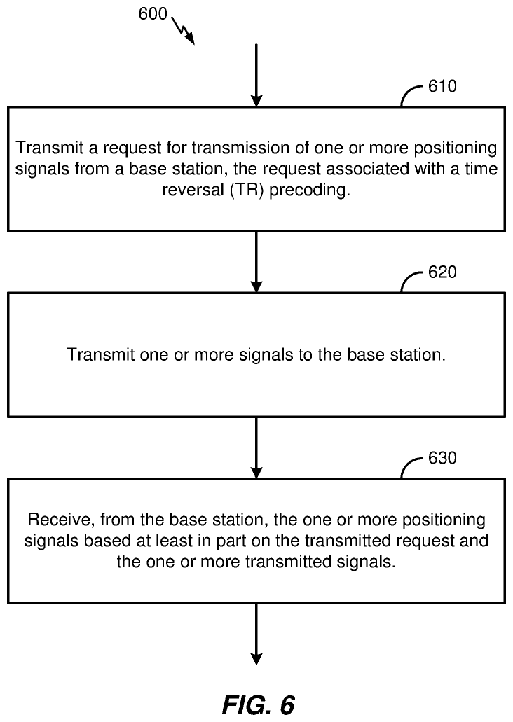

FIG. 3C shows a schematic block diagram illustrating certain example features of a UE 300C, e.g., which may be UE 104 shown in FIG. 1 or UE 350 of FIG. 3A, according to some implementations. The UE 300C may perform the process flow shown in FIG. 6. UE 300C may, for example, include one or more processors 302C, memory 304C, an external interface such as a transceiver 310C (e.g., wireless network interface), which may be operatively coupled with one or more connections 306C (e.g., buses, lines, fibers, links, etc.) to non-transitory computer readable medium 320C and memory 304C. The UE 300C may further include additional items, which are not shown, such as a user interface that may include e.g., a display, a keypad or other input device, such as virtual keypad on the display, through which a user may interface with the UE, or a satellite positioning system receiver. In certain example implementations, all or part of UE 300C may take the form of a chipset, and/or the like. Transceiver 310C may, for example, include a transmitter 312C enabled to transmit one or more signals over one or more types of wireless communication networks and a receiver 314C to receive one or more signals transmitted over the one or more types of wireless communication networks. The transceiver 310C may correspond, for example, to TX processor 368, RX processor, 356, and one or more transmitters 354a and receivers 354b as shown in FIG. 3A.

In some embodiments, UE 300C may include antenna 311C, which may be internal or external. UE antenna 311C may be used to transmit and/or receive signals processed by transceiver 310C. In some embodiments, UE antenna 311C may be coupled to transceiver 310C. In some embodiments, measurements of signals received (transmitted) by UE 300C may be performed at the point of connection of the UE antenna 311C and transceiver 310C. For example, the measurement point of reference for received (transmitted) RF signal measurements may be an input (output) terminal of the receiver 314C (transmitter 312C) and an output (input) terminal of the UE antenna 311C. In a UE 300C with multiple UE antennas 311C or antenna arrays, the antenna connector may be viewed as a virtual point representing the aggregate output (input) of multiple UE antennas. In some embodiments, UE 300C may measure received signals including signal strength and TOA measurements and the raw measurements may be processed by the one or more processors 302C.

The one or more processors 302C may be implemented using a combination of hardware, firmware, and software. For example, the one or more processors 302C may be configured to perform the functions discussed herein by implementing one or more instructions or program code 308C on a non-transitory computer readable medium, such as medium 320C and/or memory 304C. In some embodiments, the one or more processors 302C may represent one or more circuits configurable to perform at least a portion of a data signal computing procedure or process related to the operation of UE 300C.

The medium 320C and/or memory 304C may store instructions or program code 308C that contain executable code or software instructions that when executed by the one or more processors 302C cause the one or more processors 302C to operate as a special purpose computer programmed to perform the techniques disclosed herein. As illustrated in UE 300C, the medium 320C and/or memory 304C may include one or more components or modules that may be implemented by the one or more processors 302C to perform the methodologies described herein. While the components or modules are illustrated as software in medium 320C that is executable by the one or more processors 302C, it should be understood that the components or modules may be stored in memory 304C or may be dedicated hardware either in the one or more processors 302C or off the processors. A number of software modules and data tables may reside in the medium 320C and/or memory 304C and be utilized by the one or more processors 302C in order to manage both communications and the functionality described herein. It should be appreciated that the organization of the contents of the medium 320C and/or memory 304C as shown in UE 300C is merely exemplary, and as such the functionality of the modules and/or data structures may be combined, separated, and/or be structured in different ways depending upon the implementation of the UE 300C.

The medium 320C and/or memory 304C may include a positioning session module 322C that when implemented by the one or more processors 302C configures the one or more processors 302C to engage in a positioning session for the UE. For example, the one or more processors 302C may be configured to engage in a positioning session by providing positioning capabilities to a location server, via the transceiver 310C. The one or more processors 302C may be configured to receive positioning assistance data from a location server and/or serving base station, via the transceiver 310C. The one or more processors 302C may be configured to perform positioning measurements, e.g., using the transceiver 310C. The one or more processors 302C may further be configured to provide a measurement information report, via the transceiver 310C, to a network node, such as location server, serving base station or a sidelink UE.

The medium 320C and/or memory 304C may include a time reversal (TR) processing module 324C that when implemented by the one or more processors 302C configures the one or more processors 302C to enable one or more positioning signals to be filtered according to a TR precoding. For example, the one or more processors 302C may be configured to transmit a request for the transmission of one or more positioning signals by a base station according to the TR precoding, for one or more positioning signals to be transmitted without the TR precoding, and so on, as discussed in more detail below. The one or more processors 302C may be configured to transmit one or more signals to the base station, e.g., for determination of the TR precoding. The one or more processors 302C may be configured to receive the one or more positioning signals from the base station based at least in part on the transmitted request and the one or more transmitted signals.

The methodologies described herein may be implemented by various means depending upon the application. For example, these methodologies may be implemented in hardware, firmware, software, or any combination thereof. For a hardware implementation, the one or more processors 302C may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 320C or memory 304C that is connected to and executed by the one or more processors 302C. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 308C on a non-transitory computer readable medium, such as medium 320C and/or memory 304C. Examples include computer readable media encoded with a data structure and computer readable media encoded with a computer program 308C. For example, the non-transitory computer readable medium including program code 308C stored thereon may include program code 308C to support positioning of the UE using non-PRS signals for positioning measurements in a manner consistent with disclosed embodiments. Non-transitory computer readable medium 320C includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 308C in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers.

Combinations of the above should also be included within the scope of computer readable media.

In addition to storage on computer readable medium 320C, instructions and/or data may be provided as signals on transmission media included in a communication apparatus. For example, a communication apparatus may include a transceiver 310C having signals indicative of instructions and data. The instructions and data are configured to cause one or more processors to implement the functions outlined in the claims. That is, the communication apparatus includes transmission media with signals indicative of information to perform disclosed functions.

Memory 304C may represent any data storage mechanism. Memory 304C may include, for example, a primary memory and/or a secondary memory. Primary memory may include, for example, a random access memory, read only memory, etc. While illustrated in this example as being separate from one or more processors 302C, it should be understood that all or part of a primary memory may be provided within or otherwise co-located/coupled with the one or more processors 302C. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 320C. As such, in certain example implementations, the methods and/or apparatuses presented herein may take the form in whole or part of a computer readable medium 320C that may include computer implementable code 308C stored thereon, which if executed by one or more processors 302C may be operatively enabled to perform all or portions of the example operations as described herein. Computer readable medium 320C may be a part of memory 304C.

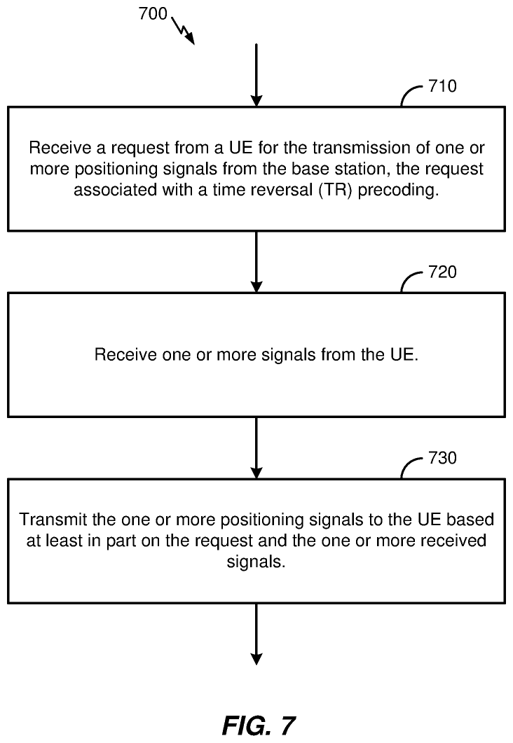

FIG. 3D shows a schematic block diagram illustrating certain example features of a base station 300D, e.g., base station 102 of FIG. 1, or base station 310 of FIG. 3A, according to some implementations. The base station 300D may be an eNB or gNB. The base station 300D may perform the process flow shown in FIG. 7. Base station 300D may, for example, include one or more processors 302D, memory 304D, an external interface, which may include a transceiver 310D (e.g., wireless network interface) and a communications interface 316D (e.g., wireline or wireless network interface to other base stations and/or entities in the core network such as a location server), which may be operatively coupled with one or more connections 306D (e.g., buses, lines, fibers, links, etc.) to non-transitory computer readable medium 320D and memory 304D. The base station 300D may further include additional items, which are not shown, such as a user interface that may include e.g., a display, a keypad or other input device, such as virtual keypad on the display, through which a user may interface with the base station. In certain example implementations, all or part of base station 300D may take the form of a chipset, and/or the like. Transceiver 310D may, for example, include a transmitter 312D enabled to transmit one or more signals over one or more types of wireless communication networks and a receiver 314D to receive one or more signals transmitted over the one or more types of wireless communication networks. The communications interface 316D may be a wired or wireless interface capable of connecting to other base stations in the RAN or network entities, such as a location server 172 shown in FIG. 1. The transceiver 310D may correspond, for example, to TX processor 316, RX processor, 370, and one or more transmitters 318a and receivers 318b as shown in FIG. 3A.

In some embodiments, base station 300D may include antenna 311D, which may be internal or external. Antenna 311D may be used to transmit and/or receive signals processed by transceiver 310D. In some embodiments, antenna 311D may be coupled to transceiver 310D. In some embodiments, measurements of signals received (transmitted) by base station 300D may be performed at the point of connection of the antenna 311D and transceiver 310D. For example, the measurement point of reference for received (transmitted) RF signal measurements may be an input (output) terminal of the receiver 314D (transmitter 312D) and an output (input) terminal of the antenna 311D. In a base station 300D with multiple antennas 311D or antenna arrays, the antenna connector may be viewed as a virtual point representing the aggregate output (input) of multiple antennas. In some embodiments, base station 300D may measure received signals including signal strength and TOA measurements and the raw measurements may be processed by the one or more processors 302D.

The one or more processors 302D may be implemented using a combination of hardware, firmware, and software. For example, the one or more processors 302D may be configured to perform the functions discussed herein by implementing one or more instructions or program code 308D on a non-transitory computer readable medium, such as medium 320D and/or memory 304D. In some embodiments, the one or more processors 302D may represent one or more circuits configurable to perform at least a portion of a data signal computing procedure or process related to the operation of base station 300D.

The medium 320D and/or memory 304D may store instructions or program code 308D that contain executable code or software instructions that when executed by the one or more processors 302D cause the one or more processors 302D to operate as a special purpose computer programmed to perform the techniques disclosed herein. As illustrated in base station 300D, the medium 320D and/or memory 304D may include one or more components or modules that may be implemented by the one or more processors 302D to perform the methodologies described herein. While the components or modules are illustrated as software in medium 320D that is executable by the one or more processors 302D, it should be understood that the components or modules may be stored in memory 304D or may be dedicated hardware either in the one or more processors 302D or off the processors. A number of software modules and data tables may reside in the medium 320D and/or memory 304D and be utilized by the one or more processors 302D in order to manage both communications and the functionality described herein. It should be appreciated that the organization of the contents of the medium 320D and/or memory 304D as shown in base station 300D is merely exemplary, and as such the functionality of the modules and/or data structures may be combined, separated, and/or be structured in different ways depending upon the implementation of the base station 300D.

The medium 320D and/or memory 304D may include a positioning session module 322D that when implemented by the one or more processors 302D configures the one or more processors 302D to engage in a positioning session for the UE. For example, the one or more processors 302D may be configured transmit and receive positioning messages with the UE 104 and the location server 172.

The medium 320D and/or memory 304D may include a TR processing module 324D that when implemented by the one or more processors 302D configures the one or more processors 302D to transmit one or more positioning signals to a UE based on a TR precoding. For example, the one or more processors 302D may be configured to receive a request for the transmission of one or more positioning signals by a base station according to the TR precoding, for one or more positioning signals to be transmitted without the TR precoding, and so on, as discussed in more detail below. The one or more processors 302D may be configured to receive one or more signals from the UE, e.g., for determination of the TR precoding. The one or more processors 302D may be configured to transmit the one or more positioning signals to the UE based at least in part on the received request and the one or more received signals.

The methodologies described herein may be implemented by various means depending upon the application. For example, these methodologies may be implemented in hardware, firmware, software, or any combination thereof. For a hardware implementation, the one or more processors 302D may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 320D or memory 304D that is connected to and executed by the one or more processors 302D. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 308D on a non-transitory computer readable medium, such as medium 320D and/or memory 304D. Examples include computer readable media encoded with a data structure and computer readable media encoded with a computer program 308D. For example, the non-transitory computer readable medium including program code 308D stored thereon may include program code 308D to support positioning of the UE using non-PRS signals for positioning measurements in a manner consistent with disclosed embodiments. Non-transitory computer readable medium 320D includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 308D in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 320D, instructions and/or data may be provided as signals on transmission media included in a communication apparatus. For example, a communication apparatus may include a transceiver 310D having signals indicative of instructions and data. The instructions and data are configured to cause one or more processors to implement the functions outlined in the claims. That is, the communication apparatus includes transmission media with signals indicative of information to perform disclosed functions.

Memory 304D may represent any data storage mechanism. Memory 304D may include, for example, a primary memory and/or a secondary memory. Primary memory may include, for example, a random access memory, read only memory, etc. While illustrated in this example as being separate from one or more processors 302D, it should be understood that all or part of a primary memory may be provided within or otherwise co-located/coupled with the one or more processors 302D. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 320D. As such, in certain example implementations, the methods and/or apparatuses presented herein may take the form in whole or part of a computer readable medium 320D that may include computer implementable code 308D stored thereon, which if executed by one or more processors 302D may be operatively enabled to perform all or portions of the example operations as described herein. Computer readable medium 320D may be a part of memory 304D.

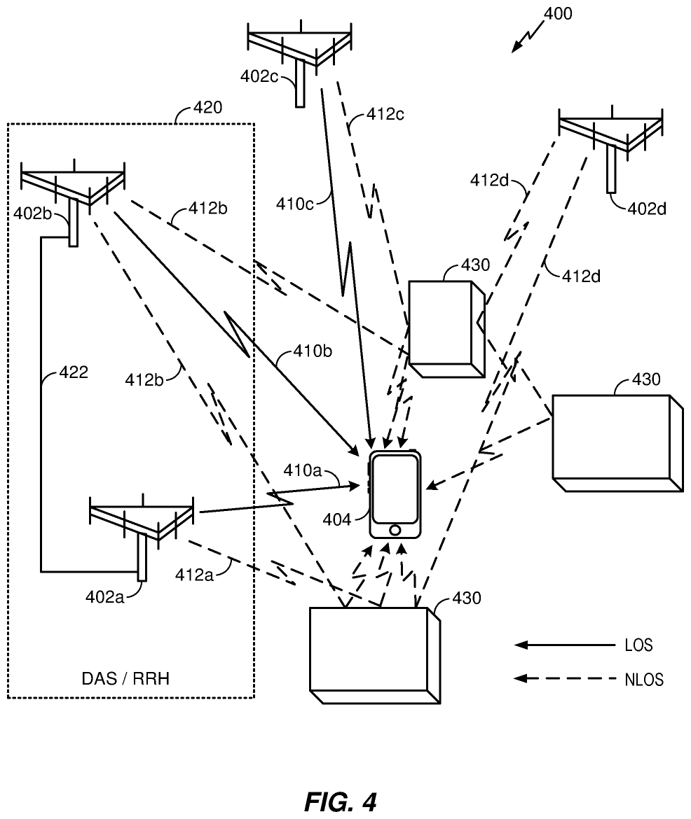

FIG. 4 illustrates an example wireless communications system 400 according to an aspect. In the example of FIG. 4, a UE 404, which may correspond to any of the UEs described above with respect to FIGS. 1, 2 and 3 (e.g., UEs 104, UE 182, UE 190, 240, 350, etc.), may be attempting to calculate or otherwise estimate its position, or assist another entity (e.g., a base station or core network component, another UE, a location server, a third party application, etc.) to calculate or otherwise estimate its position. The UE 404 may communicate wirelessly with a plurality of base stations 402a-d (collectively, base stations 402), which may correspond to any combination of base stations described above with respect to FIGS. 1, 2 and 3 (e.g., 102, 102′, 150, 180, 222, 224, 310, etc.), using RF signals and standardized protocols for the modulation of the RF signals and the exchange of information packets. By extracting different types of information from the exchanged RF signals and utilizing the layout of the wireless communications system 400 (i.e., the base stations' locations, geometry, etc.), the UE 404 may determine its position, or assist in the determination of its position, in a predefined reference coordinate system. In an aspect, the UE 404 may specify its position using two-dimensional coordinate system and/or three-dimensional coordinate system. Additionally, while FIG. 4 illustrates one UE 404 and four base stations 402, as will be appreciated, there may be more UEs 404 and more or fewer base stations 402.

To support position estimates, the base stations 402 may be configured to broadcast reference RF signals (e.g., Positioning Reference Signals (PRS), Cell-specific Reference Signals (CRS), Channel State Information Reference Signals (CSI-RS), synchronization signal blocks (SSB), Timing Reference Signals (TRS), etc.) to UEs 404 in their coverage area to enable a UE 404 to measure reference RF signal timing differences (e.g., OTDOA, RTT or RSTD) between pairs of network nodes and/or to identify the beam that best excite the LOS or shortest radio path between the UE 404 and the transmitting base stations 402. Identifying the LOS/shortest path beam(s) is of interest not only because these beams can subsequently be used for OTDOA measurements between a pair of base stations 402, but also because identifying these beams can directly provide some positioning information based on the beam direction. Moreover, these beams can subsequently be used for other position estimation methods that require precise ToA, such as round-trip time estimation based methods. Alternatively or in addition thereto, the beams may be used for angle-based positioning methods such as methods based on angle of arrival (AoA) and/or angle of departure (AoD).

As used herein, a “network node” may be a base station 402, a cell of a base station 402, a remote radio head, an antenna of a base station 402, where the locations of the antennas of a base station 402 are distinct from the location of the base station 402 itself, or any other network entity capable of transmitting reference signals. Further, as used herein, a “node” may refer to either a network node or a UE.

A location server (e.g., location server 230, LMF 270) may send assistance data to the UE 404 that includes an identification of one or more neighbor cells of base stations 402 and configuration information for reference RF signals transmitted by each neighbor cell. Location Management Function (LMF) may be an example of the location server in 5G, and Enhanced Serving Mobile Location Center (e-SMLC) in LTE. Alternatively, the assistance data can originate directly from the base stations 402 themselves (e.g., in periodically broadcasted overhead messages, etc.). Alternatively, the UE 404 can detect neighbor cells of base stations 402 itself without the use of assistance data. The UE 404 (e.g., based in part on the assistance data, if provided) may measure and (optionally) report the OTDOA from individual network nodes and/or RSTDs between reference RF signals received from pairs of network nodes. Using these measurements and the known locations of the measured network nodes (i.e., the base station(s) 402 or antenna(s) that transmitted the reference RF signals that the UE 404 measured), the UE 404 or the location server can determine the distance between the UE 404 and the measured network nodes and thereby calculate the location of the UE 404.

The term “position estimate” is used herein to refer to an estimate of a position for a UE 404, which may be geographic (e.g., may comprise a latitude, longitude, and possibly altitude) or civic (e.g., may comprise a street address, building designation, or precise point or area within or nearby to a building or street address, such as a particular entrance to a building, a particular room or suite in a building, or a landmark such as a town square). A position estimate may also be referred to as a “location,” a “position,” a “fix,” a “position fix,” a “location fix,” a “location estimate,” a “fix estimate,” or by some other term. The means of obtaining a location estimate may be referred to generically as “positioning,” “locating,” or “position fixing.” A particular solution for obtaining a position estimate may be referred to as a “position solution.” A particular method for obtaining a position estimate as part of a position solution may be referred to as a “position method” or as a “positioning method.”

The term “base station” may refer to a single physical transmission point or to multiple physical transmission points that may or may not be co-located. For example, where the term “base station” refers to a single physical transmission point, the physical transmission point may be an antenna of the base station (e.g., base station 402) corresponding to a cell of the base station. Where the term “base station” refers to multiple co-located physical transmission points, the physical transmission points may be an array of antennas (e.g., as in a MIMO system or where the base station employs beamforming) of the base station. Where the term “base station” refers to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station). Alternatively, the non-co-located physical transmission points may be the serving base station receiving the measurement report from the UE (e.g., UE 404) and a neighbor base station whose reference RF signals the UE is measuring. Thus, FIG. 4 illustrates an aspect in which base stations 402a and 402b form a DAS/RRH 420. For example, the base station 402a may be the serving base station of the UE 404 and the base station 402b may be a neighbor base station of the UE 404. As such, the base station 402b may be the RRH of the base station 402a. The base stations 402a and 402b may communicate with each other over a wired or wireless link 422.

To accurately determine the position of the UE 404 using the OTDOAs, RTTs and/or RSTDs between RF signals received from pairs of network nodes, the UE 404 may measure the reference RF signals received over the LOS path (or the shortest NLOS path where an LOS path is not available), between the UE 404 and a network node (e.g., base station 402, antenna). However, RF signals travel not only by the LOS/shortest path between the transmitter and receiver, but also over a number of other paths as the RF signals spread out from the transmitter and reflect off other objects such as hills, buildings, water, and the like on their way to the receiver. Thus, FIG. 4 illustrates a number of LOS paths 410 and a number of NLOS paths 412 between the base stations 402 and the UE 404. Specifically, FIG. 4 illustrates base station 402a transmitting over an LOS path 410a and an NLOS path 412a, base station 402b transmitting over an LOS path 410b and two NLOS paths 412b, base station 402c transmitting over an LOS path 410c and an NLOS path 412c, and base station 402d transmitting over two NLOS paths 412d. As illustrated in FIG. 4, each NLOS path 412 reflects off some object 430 (e.g., a building). As will be appreciated, each LOS path 410 and NLOS path 412 transmitted by a base station 402 may be transmitted by different antennas of the base station 402 (e.g., as in a MIMO system), or may be transmitted by the same antenna of a base station 402 (thereby illustrating the propagation of an RF signal). Further, as used herein, the term “LOS path” refers to the shortest path between a transmitter and receiver, and may not be an actual LOS path, but rather, the shortest NLOS path.

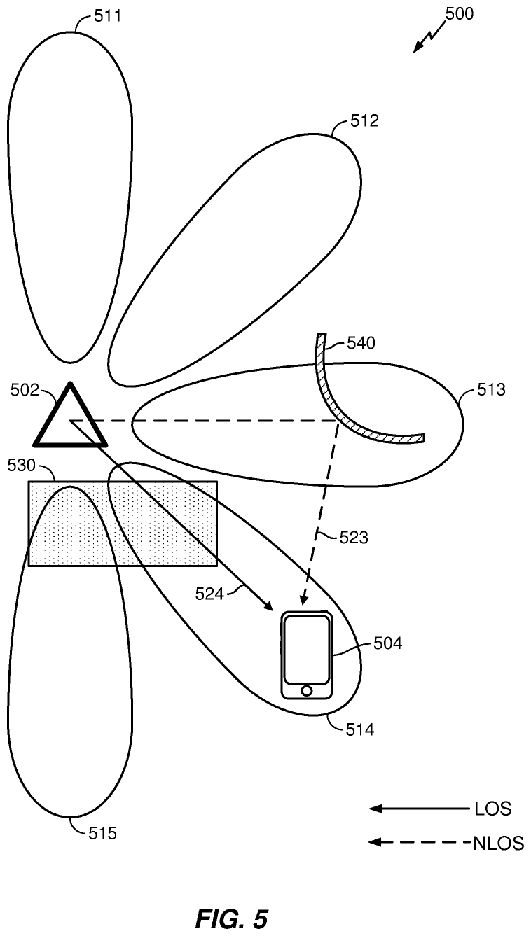

In an aspect, one or more of base stations 402 may be configured to use beamforming to transmit RF signals. In that case, some of the available beams may focus the transmitted RF signal along the LOS paths 410 (e.g., the beams produce highest antenna gain along the LOS paths) while other available beams may focus the transmitted RF signal along the NLOS paths 412. A beam that has high gain along a certain path and thus focuses the RF signal along that path may still have some RF signal propagating along other paths; the strength of that RF signal naturally depends on the beam gain along those other paths. An “RF signal” comprises an electromagnetic wave that transports information through the space between the transmitter and the receiver. As used herein, a transmitter may transmit a single “RF signal” or multiple “RF signals” to a receiver. However, as described further below, the receiver may receive multiple “RF signals” corresponding to each transmitted RF signal due to the propagation characteristics of RF signals through multipath channels.

Where a base station 402 uses beamforming to transmit RF signals, the beams of interest for data communication between the base station 402 and the UE 404 will be the beams carrying RF signals that arrive at UE 404 with the highest signal strength (as indicated by, e.g., the Reference Signal Received Power (RSRP) or SINR in the presence of a directional interfering signal), whereas the beams of interest for position estimation will be the beams carrying RF signals that excite the shortest path or LOS path (e.g., an LOS path 410). In some frequency bands and for antenna systems typically used, these will be the same beams. However, in other frequency bands, such as mmW, where typically a large number of antenna elements can be used to create narrow transmit beams, they may not be the same beams. As described below with reference to FIG. 5, in some cases, the signal strength of RF signals on the LOS path 410 may be weaker (e.g., due to obstructions) than the signal strength of RF signals on an NLOS path 412, over which the RF signals arrive later due to propagation delay.

FIG. 5 illustrates an example wireless communications system 500 according to an aspect. In the example of FIG. 5, a UE 504, which may correspond to UE 404 in FIG. 4, may be attempting to calculate or otherwise estimate its position, or to assist another entity (e.g., a base station or core network component, another UE, a location server, a third party application, etc.) to calculate or otherwise estimate its position. The UE 504 may communicate wirelessly with a base station 502, which can correspond to one of base stations 402 in FIG. 4, using RF signals and standardized protocols for the modulation of the RF signals and the exchange of information packets.

As illustrated in FIG. 5, the base station 502 may be utilizing beamforming to transmit a plurality of beams 511-515 of RF signals. Each beam 511-515 may be formed and transmitted by an array of antennas of the base station 502. Although FIG. 5 illustrates a base station 502 transmitting five beams, as will be appreciated, there may be more or fewer than five beams, beam shapes such as peak gain, width, and side-lobe gains may differ amongst the transmitted beams, and some of the beams may be transmitted by a different base station.

A beam index may be assigned to each of the plurality of beams 511-515 for purposes of distinguishing RF signals associated with one beam from RF signals associated with another beam. Moreover, the RF signals associated with a particular beam of the plurality of beams 511-515 may carry a beam index indicator. A beam index may also be derived from the time of transmission, e.g., frame, slot and/or OFDM symbol number, of the RF signal. The beam index indicator may be, for example, a three-bit field for uniquely distinguishing up to eight beams. If two different RF signals having different beam indices are received, this would indicate that the RF signals were transmitted using different beams. If two different RF signals share a common beam index, this would indicate that the different RF signals are transmitted using the same beam. Another way to describe that two RF signals are transmitted using the same beam is to say that the antenna port(s) used for the transmission of the first RF signal are spatially quasi-collocated with the antenna port(s) used for the transmission of the second RF signal.

In the example of FIG. 5, the UE 504 may receive an NLOS data stream 523 of RF signals transmitted on beam 513 and an LOS data stream 524 of RF signals transmitted on beam 514. Although FIG. 5 illustrates the NLOS data stream 523 and the LOS data stream 524 as single lines (dashed and solid, respectively), as will be appreciated, the NLOS data stream 523 and the LOS data stream 524 may each comprise multiple rays (i.e., a “cluster”) by the time they reach the UE 504 due, for example, to the propagation characteristics of RF signals through multipath channels. For example, a cluster of RF signals may be formed when an electromagnetic wave is reflected off of multiple surfaces of an object, and reflections arrive at the receiver (e.g., UE 504) from roughly the same angle, each travelling a few wavelengths (e.g., centimeters) more or less than others. A “cluster” of received RF signals generally corresponds to a single transmitted RF signal.

In the example of FIG. 5, the NLOS data stream 523 is not originally directed at the UE 504, although, as will be appreciated, it could be, as are the RF signals on the NLOS paths 412 in FIG. 4. However, it is reflected off a reflector 540 (e.g., a building) and reaches the UE 504 without obstruction, and therefore, may still be a relatively strong RF signal. In contrast, the LOS data stream 524 is directed at the UE 504 but passes through an obstruction 530 (e.g., vegetation, a building, a hill, a disruptive environment such as clouds or smoke, etc.), which may significantly degrade the RF signal. As will be appreciated, although the LOS data stream 524 is weaker than the NLOS data stream 523, the LOS data stream 524 will arrive at the UE 504 before the NLOS data stream 523 because it follows a shorter path from the base station 502 to the UE 504.

As noted above, the beam of interest for data communication between a base station (e.g., base station 502) and a UE (e.g., UE 504) is the beam carrying RF signals that arrives at the UE with the highest signal strength (e.g., highest RSRP or SINR), whereas the beam of interest for position estimation is the beam carrying RF signals that excite the LOS path and that has the highest gain along the LOS path amongst all other beams (e.g., beam 514). That is, even if beam 513 (the NLOS beam) were to weakly excite the LOS path (due to the propagation characteristics of RF signals, even though not being focused along the LOS path), that weak signal, if any, of the LOS path of beam 513 may not be as reliably detectable (compared to that from beam 514), thus leading to greater error in performing a positioning measurement.

While the beam of interest for data communication and the beam of interest for position estimation may be the same beams for some frequency bands, for other frequency bands, such as mmW, they may not be the same beams. As such, referring to FIG. 5, where the UE 504 is engaged in a data communication session with the base station 502 (e.g., where the base station 502 is the serving base station for the UE 504) and not simply attempting to measure reference RF signals transmitted by the base station 502, the beam of interest for the data communication session may be the beam 513, as it is carrying the unobstructed NLOS data stream 523. The beam of interest for position estimation, however, would be the beam 514, as it carries the strongest LOS data stream 524, despite being obstructed.

New Radio (NR) DL PRS resource may be defined as a set of resource elements used for NR DL PRS transmission that can span multiple physical resource blocks (PRBs) within N consecutive symbols within a slot, where N is one or more. In any OFDM symbol, a PRS resource may occupy consecutive PRBs. A DL PRS Resource Set may be defined as a set of DL PRS Resources, in which each DL PRS Resource has a DL PRS Resource ID. The DL PRS Resources in a DL PRS Resource set may be associated with a same Tx/Rx point (TRP).

A DL PRS Resource ID in a DL PRS Resource set may be associated with a single beam transmitted from a single TRP. Note that a TRP may transmit one or more beams. This may or may not have any implications on whether the TRPs and beams from which signals are transmitted are known to the UE. A DL PRS occasion may be viewed as one instance of periodically repeated time windows (e.g., consecutive slots) where DL PRS is expected to be transmitted. A DL PRS configuration including DL PRS transmission schedule can be indicated to the UE for DL PRS positioning measurements. Note that the UE may not be expected to perform any blind detection of DL PRS configurations.

Accuracy of radio based positioning can be severely affected by the NLOS multipath propagation, which is unavoidable for some scenarios, such as in urban areas and indoor environments. In distance/range estimation (such as through ToA measurement), the detection of the first or the LOS path is challenging in presence of NLOS multipath propagation channels.

At low SNR (signal-to-noise ratio) and/or at low SINR (signal-to-interference-plus-noise ratio), the first path with low power may not be successfully detected by the receiver. Thus one significant issue may be framed as how to enhance the capability to detect the first path in even in the presence of NLOS multipath channel under low SNR and/or SINR.

Aspects of the present disclosure provide methods and systems for using time-reversal (TR) filtering to enhance the first or LOS path detection capabilities. In TR transmission, a reference signal S may be pre-filtered with a time-reversal filter:

Sₜ=S [symbol] h(−t)* (1)

In equation (1), the time-reversal filter h(−t)* is the time-reversed channel impulse response (CIR) between a transmitter (e.g., one of UE and gNB) and a receiver (e.g., other of UE and gNB). The filtered signal Sₜ may be transmitted.

The signal Y received at the receiver may be written as:

Y=S [symbol] h(−t)* [symbol] h(t) (2)

At the receiver side, the equivalent CIR is Rₕₕ=h(−t)* [symbol] h(t), which is the channel autocorrelation.

Since TR filtering can compress the multipath channel, it can increase the SNR and improve the estimation accuracy. This technique to increase the SNR relies upon the knowledge of the channel, in particular, the CIR h(t) of the channel. Thus, in an aspect, TR precoding (TR filtering) of a reference signal (RS) at the transmitter may be based on a channel state information (CSI) between the transmitter and the receiver (e.g., CSI between a UE and a gNB) from which h(t) may be estimated.

The TR-based positioning may be applied in the uplink (UL) and/or in the downlink (DL) direction. Reference signals for TR-based positioning in UL will be generically referred to as uplink reference signals (UL RS). Similarly, reference signals for TR-based positioning in the DL will be generically referred to as downlink reference signals (DL RS). Examples of UL RS may include sounding reference signal (SRS), demodulation reference signal (DMRS), phase tracking reference signal (PTRS), etc. Examples of DL RS may include positioning reference signal (PRS), channel state information reference signal (CSI-RS), DMRS, primary synchronization signal (PSS), secondary synchronization signal (SSS), PTRS, etc. For signals such as DMRS and PTRS that may be transmitted in both UL (e.g., by the UE) and DL (e.g., by the gNB) directions, the signals may be prepended with UL or DL to distinguish. For example UL DMRS may be differentiated from DL DMRS.

It would be desirable for wireless devices, such as gNBs, UEs, and location servers, to support on-demand TR-based positioning on the downlink. That is, a UE or a location server may request transmission of one or more TR precoded DL RS (such as one or more PRS) to be transmitted to a particular UE. The TR precoding may be based on one or more UL RS transmitted by the particular UE. For example, a channel impulse response may be determined or estimated based on the UL RS and the TR precoding filter derived from the channel impulse response as described above. Note that while this TR-precoded DL RS is intended for use by the particular UE, that in some aspects, one or more other UEs may also use the TR-precoded DL RS for positioning. For example, one or more UE's nearby the particular UE may be able to use the TR-precoded DL RS for positioning. For example, a location server may indicate when a TR-precoded DL RS may be used by another UE.

In some examples, the TR filter may be determined based on one or more SRS transmitted by the particular UE. That is, the UL RS transmitted by the particular UE may include one or more SRS. Note that while the SRS may not be transmitted over the same frequency band as the TR-precoded DL RS, that overlap between an UL frequency band over which the SRS is transmitted and a DL frequency band over which the TR-precoded DL RS is transmitted may improve the performance gain of TR. For example, even when only 15-20 MHz of overlap between the UL frequency band and the DL frequency band, the performance gain from using TR may be beneficial. The UL channel response may then be estimated based on the one or more SRS as received by the base station.

In some examples, the TR filter may be determined based on one or more CSI-RS. That is, the particular UE may receive the CSI-RS, and determine CSI for the DL channel based on the CSI-RS. The particular UE may then indicate the CSI in one or more signals transmitted to the base station or location server. That is, one or more UL signals transmitted by the particular UE may include this CSI determined from the one or more received CSI-RS. For example, the UL signals may include one or more physical uplink control channel (PUCCH signals), one or more physical uplink shared channel (PUSCH) signals. Such UL signals transmitted by the particular UE may include a CSI-RS report message indicating the CSI. Each CSI-RS report message may include a timestamp, and each CSI-RS and CSI-RS report may be associated with a specific on-demand DL RS. The CSI indicated by the particular UE may take any of a number of forms, for example because different UEs may have differing capabilities for processing the CSI-RS. In some aspects, the CSI may include a channel impulse response or channel frequency response, and may include a partial channel impulse response, a shortened channel impulse response, a wideband channel frequency response, or a narrowband channel frequency response. In some other aspects, the CSI may include a power delay profile (PDP), a doppler shift measurement. Depending on the frequency of the signals used for the doppler shift measurement, timing of the doppler shift measurement relative to the TR-precoded DL RS may be constrained. For example, for higher frequency signals, it may be beneficial to schedule the doppler shift measurement closer in time to the TR-precoded DL RS as compared with lower frequency signals. In some aspects, use of CSI-RS and CSI-RS report message may be preferred over SRS-based techniques for systems operating using frequency division duplexing (FDD), for example due to the lack of channel reciprocity in such systems.

In some aspects, on-demand TR processing of DL positioning signals may be requested by the particular UE that is to receive the TR-precoded DL RS. For example, a UE may request TR precoding for a specific on-demand PRS to be received by the UE. Associated with such a request, the UE may indicate one or more types of UL RS it supports for indicating channel conditions, such as CSI, between the UE and the base station. For example, the UE may indicate whether it supports feedback of CSI based on one or more CSI-RS, whether or not it supports SRS transmission associated with the on-demand PRS, and so on.

In some aspects, on-demand TR processing of DL positioning signals may be requested by a location server associated with the particular UE and the base station. For example, the location server may indicate relevant features of the on-demand TR processing, such as the particular UE to be addressed by the TR-precoded DL RS, the base station to transmit the TR-precoded DL RS, the type of CSI feedback to be employed by the particular UE (e.g., SRS, CSI based on CSI-RS, and so on), a time for the particular UE to transmit the CSI feedback, and so on. In some examples, the location server may request that the particular UE transmit its CSI feedback or SRS at a particular time, such as within a threshold time of transmission of the TR-precoded DL RS. Such temporal proximity between measurement of the UL channel conditions and the transmission of the TR-precoded DL RS may improve channel reciprocity and increase the accuracy of the derived TR precoding.

In some aspects, the base station, such as a gNB, may derive the TR precoding based on the channel information received from the UE, as discussed above. For example, the gNB may derive the TR precoding based on one or more SRS or CSI-RS reports transmitted by the UE. In some other aspects, the base station may signal the channel information, such as the CSI, to a location server. In response, the location server may indicate a TR precoder, such as a TR filter as discussed above, for the base station to use in the TR-precoded DL RS. Alternatively, the location server may indicate that the base station may select its own TR precoder. For implementations where the base station may select its own TR precoder, the base station may indicate to the location server the beam pattern, such as a 3 dB beamwidth, of the TR-precoded DL RS. It may be important for the base station to indicate the beam pattern to the location server when the positioning technique is AoD based positioning. The location server may then update its beam pattern information and indicate the updated beam pattern to the particular UE in positioning assistance data. The location server updating the beam pattern information and indicating this updated information to the UE in the positioning assistance data may be important when the base station is a non-serving base station, as positioning assistance is typically signaled through serving cells.

After determining the TR precoding, the base station may apply the TR precoding to one or more DL RS, such as one or more PRS, and transmit the TR precoded DL RS to the particular UE. The UE may then use the one or more TR precoded DL RS for positioning, as discussed above.

In some aspects, rather than measuring channel state information using CSI-RS, or by transmitting one or more SRS, the channel state information for an on-demand TR-precoded DL RS may be determined by a UE based on one or more previously transmitted TR precoded DL RS. That is, a UE may use one or more TR-precoded DL RS associated with a previously requested DL RS requested by the same particular UE or requested by a different UE. In some aspects, the different UE may be located proximate to the particular UE. In some aspects, the location server may indicate when a TR-precoded DL RS may be associated with a future on-demand DL RS.

The above techniques have been described with respect to requesting TR precoding for on-demand DL RS. However, use of TR may require channel reciprocity. Thus, if channel reciprocity is sufficiently weak, TR precoding may be inappropriate. Accordingly, in some aspects, a request for on-demand DL RS may include requesting TR precoding to be disabled. For example, a base station, or a UE may request that the location server disable TR processing of the DL RS. Requesting disablement of TR processing may be based on channel reciprocity measured by the UE or the base station. In some aspects, when a UE requests an on-demand DL RS, the request may include a request to disable TR processing of the DL RS. In some other aspects, the base station may indicate to the UE that channel reciprocity is poor, and this indication may trigger the cancellation of TR precoding in the on-demand DL RS. In some aspects, the base station or the UE may signal the measured channel reciprocity, such as a measure of channel overlap, a correlation of one or more channel impulse response or channel frequency response, and so on. In some aspects, recent movement of the UE may trigger a request to disable TR processing, for example because movement of the UE may cause changes in channel conditions, thus decreasing the relevance, for example, of CSI measured before the UE's movement.

The above techniques describe requesting TR precoding for an on-demand DL RS, as well as requesting the omission or disabling of TR processing for an on-demand DL RS. In both cases, the requested on-demand DL RS may be described as “associated with” a TR precoding.

FIG. 6 illustrates a flowchart of an example method 600 of a user equipment (UE) according to one or more aspects. In an aspect, the memory 360 of the UE 350 in FIG. 3A may be an example of a computer-readable medium that stores computer executable instructions for one or more of the TX processor 368, the controller/processor 359, the RX processor 356, and/or the channel estimator 358 of the UE 350 to perform the method 600.

In block 610, the UE transmits a request for transmission of one or more positioning signals from a base station, the request associated with a time reversal (TR) precoding. In some aspects, a means for transmitting a request for transmission of one or more positioning signals from a base station may include the antenna 352, the receiver 354a, the RX processor 356, the controller/processor 359, and the memory 360.

In block 620, the UE transmits one or more signals to the base station. In some aspects, a means for transmitting the one or more signals to the base station may include the antenna 352, the receiver 354a, the RX processor 356, the controller/processor 359, and the memory 360.

In block 630 the UE receives, from the base station, the one or more positioning signals based at least in part on the transmitted request and the transmitted one or more signals. In some aspects, a means for receiving the one or more positioning signals may include the antenna 352, the transmitter 354b, the TX processor 368, the controller/processor 359, and the memory 360.

In some aspects, the request in block 610 may be a request for the base station to transmit the one or more positioning signals using the TR precoding, where each of the one or more positioning signals are encoded according to the TR precoding. In some aspects, the one or more positioning signals include one or more PRS. In some aspects, the one or more transmitted signals include one or more SRS. The one or more SRS may be transmitted over a frequency band at least partially overlapping with a frequency band over which the one or more positioning signals are received. In some aspects, the one or more transmitted signals are based at least in part on CSI measured from a previously received positioning signal received from the base station. In some aspects, the one or more transmitted signals indicate CSI derived from one or more CSI-RS received by the UE. In some aspects, the CSI derived from the one or more CSI-RS may include one or more of a channel impulse response, a channel frequency response, a partial channel impulse response, a shortened channel impulse response, a power delay profile (PDP), a wideband channel frequency response, a narrowband frequency response, or a doppler shift measurement. In some aspects, the operation 600 may include prior to requesting the transmission of the one or more positioning signals, the UE may indicate to a location server whether or not the UE supports transmission of CSI feedback or transmission of one or more SRS signals associated with the reception of the one or more positioning signals. In some aspects, the method 600 may include, prior to transmitting the one or more signals to the base station, receiving a request to transmit the one or more signals at a specified time, where the one or more signals are transmitted at the specified time. The specified time may be within a threshold time of a time for receiving the one or more positioning signals.

In some aspects, the request transmitted in block 610 may include a request for the one or more positioning signals to be transmitted without using the TR precoding. In some aspects, the request to transmit the one or more positioning signals without the TR precoding may be transmitted in response to insufficient channel reciprocity between the UE and the base station.

FIG. 7 illustrates a flowchart of an example method 700 of a base station, according to one or more aspects. In an aspect, the memory 376 of the base station 310 in FIG. 3A may be an example of a computer-readable medium that stores computer executable instructions for one or more of the TX processor 316, the controller/processor 375, the RX processor 370, and/or the channel estimator 374 of the base station 310 to perform the method 700.

In block 710, the base station receives a request from a UE for the transmission of one or more positioning signals from the base station, where the request is associated with a time reversal (TR) precoding. In some aspects, a means for receiving the request from the UE may include the antenna 320, the receiver 318b, the RX processor 370, the controller/processor 375, and the memory 376.

In block 720, the base station receives one or more signals from the UE. In some aspects, a means for receiving the one or more signals from the UE may include the antenna 320, the receiver 318b, the RX processor 370, the controller/processor 375, and the memory 376.

In block 730, the base station transmits the one or more positioning signals to the UE based at least in part on the request and the one or more received signals. In some aspects, a means for transmitting the one or more positioning signals may include the antenna 320, the transmitter 318a, the TX processor 316, the controller/processor 375, and the memory 376.

In some aspects, the request received in block 710 is a request for the base station to transmit the one or more positioning signals using the TR precoding, and the one or more positioning signals are transmitted using the TR precoding in block 730. In some aspects, the one or more positioning signals include one or more PRS. In some aspects, the one or more received signals include one or more SRS. The one or more SRS may be received over a frequency band at least partially overlapping with a frequency band over which the one or more positioning signals are transmitted. In some aspects, the one or more signals received in block 720 are based at least in part on CSI measured from a previously transmitted positioning signal transmitted by the base station. In some aspects, the one or more signals received in block 720 indicate CSI derived from one or more CSI-RS. In some aspects, the one or more signals received in block 720 include CSI including one or more of a channel impulse response, a channel frequency response, a partial channel impulse response, a shortened channel impulse response, a power delay profile (PDP), a wideband channel frequency response, a narrowband frequency response, or a doppler shift measurement. In some aspects, the method 700 includes, prior to receiving the one or more signals from the UE in block 720, requesting the UE to transmit the one or more signals at a specified time, where the one or more signals are received at the specified time. The specified time may be within a threshold time of a time for transmitting the one or more positioning signals.

In some aspects, the method 700 may include encoding the one or more positioning signals according to the TR precoding by determining one or more channel impulse responses (CIRs) h(t) based on the one or more signals received from the UE, deriving one or more TR filters h(−t)* based on the one or more CIRs, generating one or more TR precoders H(f) based on the one or more TR filters h(−t)*; and encoding the positioning signals based one the generated one or more TR precoders H(f).

In some aspects, the request received in block 710 is a request for the one or more positioning signals to be transmitted without using the TR precoding.

In some aspects, the request received in block 710 may be received from a location server. In some aspects, the request received in block 710 may be received from the UE.

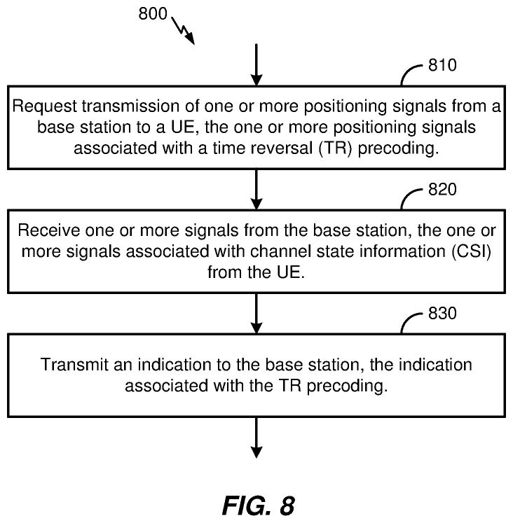

FIG. 8 illustrates a flowchart of an example method 800 of a location server, according to one or more aspects. The method 800 may be performed by a location server, such as location server 230, LMF 270, or location server 300B. For example, the server 300B may perform the method 800 by the processor 301B executing instructions stored on nonvolatile memory 303B.

In block 810, the location server requests transmission of one or more positioning signals from a base station to a UE, the one or more positioning signals associated with a time reversal (TR) precoding. In some aspects, a means for requesting transmission of the one or more positioning signals may include the processor(s) 302B, the memory 304B, the medium 308B, the communications interface 316B, and the TR processing module 324B.

In block 820, the location server receives one or more signals from the base station, the one or more signals associated with CSI from the UE. In some aspects, a means for receiving the one or more signals from the base station may include the processor(s) 302B, the memory 304B, the medium 308B, the communications interface 316B, and the TR processing module 324B.

In block 830, the location server transmits an indication to the base station, the indication associated with the TR precoding. In some aspects, a means for transmitting the indication to the base station may include the processor(s) 302B, the memory 304B, the medium 308B, the communications interface 316B, and the TR processing module 324B.

In some aspects, transmitting the indication in block 830 includes signaling the TR precoding the base station is to use when transmitting the one or more positioning signals to the UE. In some aspects, transmitting the indication in block 830 includes indicating that the base station is to select the TR precoding to use when transmitting the one or more positioning signals. In some aspects, the method 800 may also include receiving, from the base station, a beam pattern associated with the TR precoding and sending the received beam pattern to the UE.

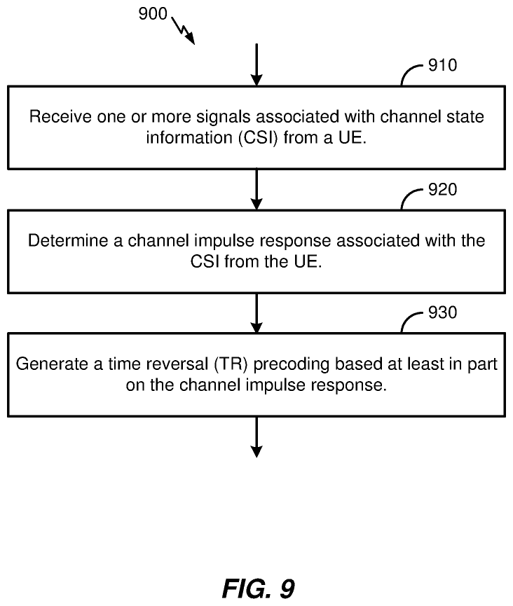

FIG. 9 illustrates a flowchart of an example method 900 for generating a time reversal (TR) precoding, according to one or more aspects. In some aspects, a base station may perform the method 900. That is, the memory 376 of the base station 310 in FIG. 3A may be an example of a computer-readable medium that stores computer executable instructions for one or more of the TX processor 316, the controller/processor 375, the RX processor 370, and/or the channel estimator 374 of the base station 310 to perform the method 700. In some other aspects, a location server may perform the method 900. That is, method 900 may be performed by a location server, such as location server 230, LMF 270, or server 300B. For example, the server 300B may perform the method 900 by the processor 301B executing instructions stored on nonvolatile memory 303B.

In block 910, the base station or location server may receive one or more signals associated with CSI from a UE. In block 920, the base station or location server may determine a channel impulse response associated with the CSI from the UE. In block 930, the base station or location server may generate a TR precoding based at least in part on the channel impulse response.

As discussed above, the TR precoding may be based on a time reversal filter h(−t)*, where h(−t)* is the time-reversed channel impulse response between a base station and a UE. Thus, determining the channel impulse response associated with the CSI from the UE allows for determination of the time reversal filter, which is applied to the one or more positioning signals, for example in blocks 630 or 730.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or other such configurations).

The methods, sequences, and/or algorithms described in connection with the aspects disclosed herein may be embodied directly in hardware, in a software module executed by a processor, or in a combination of the two. A software module may reside in Random Access Memory (RAM), flash memory, Read-Only Memory (ROM), Erasable Programmable ROM (EPROM), Electrically Erasable Programmable ROM (EEPROM), registers, hard disk, a removable disk, a CD-ROM, or any other form of non-transitory computer-readable medium known in the art. An example non-transitory computer-readable medium may be communicatively coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC. The ASIC may reside in a user device (e.g., a UE) or a base station. In the alternative, the processor and the non-transitory computer-readable medium may be discrete components in a user device or base station.

In one or more example aspects, the functions described herein may be implemented in hardware, software, firmware, or any combination thereof. If implemented in software, the functions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes a Compact Disk (CD), laser disc, optical disk, Digital Video Disk (DVD), floppy disk, and Blu-ray discs, which usually reproduce data magnetically and/or optically with lasers. Combinations of the above should also be included within the scope of computer-readable media.

While the foregoing disclosure shows illustrative aspects, those skilled in the art will appreciate that various changes and modifications could be made herein without departing from the scope of the disclosure as defined by the appended claims.

Furthermore, in accordance with the various illustrative aspects described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

Implementation examples are described in the following numbered clauses:
Clause 1. A user equipment (UE), including: a transceiver; a memory; and a processor communicatively coupled to the transceiver and the memory, the processor configured to:
transmit a request for the transmission of one or more positioning signals from a base station, the request one of a request for the base station to transmit the one or more positioning signals using a time reversal (TR) precoding or a request for the one or more positioning signals to be transmitted without using the TR precoding;
transmit one or more signals to the base station; transmit one or more signals to the base station; and
receive, from the base station, the one or more positioning signals based at least in part on the transmitted request and the one or more transmitted signals.
Clause 2. The UE of clause 1, wherein the one or more received positioning signals are encoded according to the TR precoding.
Clause 3: The UE of any of clauses 1-2, wherein the one or more positioning signals include one or more positioning reference signals (PRS).
Clause 4. The UE of any of clauses 1-3, wherein the one or more transmitted signals include one or more sounding reference signals (SRS).
Clause 5. The UE of clause 4, wherein the one or more SRS are transmitted over a frequency band at least partially overlapping with a frequency band over which the one or more positioning signals are received.
Clause 6. The UE of any of clauses 1-5, wherein the one or more transmitted signals are based at least in part on channel state information (CSI) measured from a previously received positioning signal received from the base station.
Clause 7. The UE of any of clauses 1-6, wherein the one or more transmitted signals indicate channel state information (CSI) derived from one or more CSI reference signals (CSI-RS) received by the UE.
Clause 8. The UE of clause 7, wherein the one or more transmitted signals include CSI including one or more of a channel impulse response, a channel frequency response, a partial channel impulse response, a shortened channel impulse response, a power delay profile (PDP), a wideband channel frequency response, a narrowband frequency response, or a doppler shift measurement.
Clause 9. The UE of any of clauses 1-8, wherein the processor is further configured to, prior to requesting the transmission of the one or more positioning signals, indicate to a location server whether or not the UE supports transmission of CSI feedback or transmission of one or more SRS signals associated with the reception of the one or more positioning signals.
Clause 10. The UE of any of clauses 1-9, wherein the processor, the transceiver, and the memory are configured to, prior to transmitting the one or more signals to the base station, receive a request to transmit the one or more signals at a specified time, wherein the one or more signals are transmitted at the specified time.
Clause 11: The UE of clause 1, wherein the received one or more positioning signals are not encoded according to the TR precoding.
Clause 12 The UE of clause 11, wherein the request is transmitted in response to an insufficient channel reciprocity between the UE and the base station.
Clause 13. A method for positioning in a wireless network, the method performed by a user equipment (UE) and including:
transmitting a request for the transmission of one or more positioning signals from a base station, the request one of a request for the base station to transmit the one or more positioning signals using a time reversal (TR) precoding or a request for the one or more positioning signals to be transmitted without using the TR precoding;
transmitting one or more signals to the base station; and
receiving, from the base station, the one or more positioning signals based at least in part on the transmitted request and the one or more transmitted signals.
Clause 14. The method of clause 13, wherein the received one or more positioning signals are encoded according to the TR precoding.
Clause 15. The method of clause 14, wherein the one or more positioning signals include one or more positioning reference signals (PRS).
Clause 16. The method of any of clauses 14-15, wherein the one or more transmitted signals include one or more sounding reference signals (SRS).
Clause 17. The method of clause 16, wherein the one or more SRS are transmitted over a frequency band at least partially overlapping with a frequency band over which the one or more positioning signals are received.
Clause 18. The method of any of clauses 14-17, wherein the one or more transmitted signals are based at least in part on channel state information (CSI) measured from a previously received positioning signal received from the base station.
Clause 19. The method of any of clauses 14-18, wherein the one or more transmitted signals indicate channel state information (CSI) derived from one or more CSJ reference signals (CSJ-RS) received by the UE.
Clause 20. The method of clause 19, wherein the one or more transmitted signals include CSI including one or more of a channel impulse response, a channel frequency response, a partial channel impulse response, a shortened channel impulse response, a power delay profile (PDP), a wideband channel frequency response, a narrowband frequency response, or a doppler shift measurement.
Clause 21. The method of any of clauses 14-20, further including, prior to requesting the transmission of the one or more positioning signals, indicating to a location server whether or not the UE supports transmission of CSI feedback or transmission of one or more SRS signals associated with the reception of the one or more positioning signals.
Clause 22. The method of any of clauses 14-21, further including, prior to transmitting the one or more signals to the base station, receiving a request to transmit the one or more signals at a specified time, wherein the one or more signals are transmitted at the specified time.
Clause 23. The method of clause 13, wherein the transmitted one or more positioning signals are not encoded according to the TR precoding.
Clause 24. The method of clause 23, wherein the request is transmitted in response to an insufficient channel reciprocity between the UE and the base station.
Clause 25. A user equipment (UE), including:
means for transmitting a request for the transmission of one or more positioning signals from a base station, the request one of a request for the base station to transmit the one or more positioning signals using a time reversal (TR) precoding or a request for the one or more positioning signals to be transmitted without using the TR precoding;
means for transmitting one or more signals to the base station; and
means for receiving, from the base station, the one or more positioning signals based at least in part on the transmitted request and the one or more transmitted signals.
Clause 26. The UE of clause 25, wherein the one or more positioning signals are encoded according to the TR precoding.
Clause 27. The UE of any of clauses 25-26, wherein the one or more transmitted signals indicate channel state information (CSI) derived from one or more CSI reference signals (CSI-RS) received by the UE.
Clause 28. The method of clause 25, wherein the one or more positioning signals are transmitted without using the TR precoding.
Clause 29. A base station, including:
a transceiver;
a memory; and
a processor communicatively coupled to the transceiver and the memory,
the processor configured to:
receive a request for the transmission of one or more positioning signals from the base station to a user equipment (UE), the request one of a request for the base station to transmit the one or more positioning signals using a time reversal (TR) precoding or a request for the one or more positioning signals to be transmitted without using the TR precoding;
receive one or more signals from the UE; and
transmit the one or more positioning signals to the UE based at least in part on the received request and the one or more received signals.
Clause 30. The base station of clause 29, wherein the one or more positioning signals are encoded according to the TR precoding.
Clause 31. The base station of any of clauses 29-30, wherein the one or more positioning signals include one or more positioning reference signals (PRS).
Clause 32. The base station of any of clauses 29-31, wherein the one or more received signals include one or more sounding reference signals (SRS).
Clause 33. The base station of clause 32, wherein the one or more SRS are received over a frequency band at least partially overlapping with a frequency band over which the one or more positioning signals are transmitted.
Clause 34. The base station of any of clauses 29-33, wherein the one or more received signals are based at least in part on channel state information (CSI) measured from a previous positioning signal transmitted by the base station.
Clause 35. The base station of any of clauses 29-34, wherein the one or more received signals indicate channel state information (CSI) derived from one or more CSI reference signals (CSI-RS).
Clause 36. The base station of clause 35, wherein the one or more received signals include CSI including one or more of a channel impulse response, a channel frequency response, a partial channel impulse response, a shortened channel impulse response, a power delay profile (PDP), a wideband channel frequency response, a narrowband frequency response, or a doppler shift measurement.
Clause 37. The base station of any of clauses 29-36, wherein the processor is further configured to, prior to receiving the one or more signals from the UE, request the UE to transmit the one or more signals at a specified time, wherein the one or more signals are received at the specified time.
Clause 38. The base station of any of clauses 29-37, wherein the processor is further configured to encode the one or more positioning signals according to the TR precoding by determining one or more channel impulse responses (CIRs) h(t) based on the one or more signals received from the UE, deriving one or more TR filters h(−t)* based on the one or more CIRs, generating one or more TR precoders H(f) based on the one or more TR filters h(−t)*; and encoding the one or more positioning signals based one the generated one or more TR precoders H(f).
Clause 39. A method for positioning in a wireless network, the method performed by a base station and including:
receiving a request from a user equipment (UE) for the transmission of one or more positioning signals from the base station, the request one of a request for the base station to transmit the one or more positioning signals using a time reversal (TR) precoding or a request for the one or more positioning signals to be transmitted without using the TR precoding;
receiving one or more signals from the UE; and
transmitting the one or more positioning signals to the UE based at least in part on the received request and the one or more received signals.
Clause 40. The method of clause 39, wherein the one or more positioning signals are encoded according to the TR precoding.
Clause 41. The method of any of clauses 39-40, wherein the one or more positioning signals include one or more positioning reference signals (PRS).
Clause 42. The method of any of clauses 39-41, wherein the one or more received signals include one or more sounding reference signals (SRS).
Clause 43. The method of clause 42, wherein the one or more SRS are received over a frequency band at least partially overlapping with a frequency band over which the one or more positioning signals are transmitted.
Clause 44. The method of any of clauses 39-43, wherein the one or more received signals are based at least in part on channel state information (CSI) measured from a previous positioning signal transmitted by the base station.
Clause 45. The method of any of clauses 39-44, wherein the one or more received signals indicate channel state information (CSI) derived from one or more CSI reference signals (CSI-RS).
Clause 46. The method of clause 45, wherein the one or more received signals include CSI including one or more of a channel impulse response, a channel frequency response, a partial channel impulse response, a shortened channel impulse response, a power delay profile (PDP), a wideband channel frequency response, a narrowband frequency response, or a doppler shift measurement.
Clause 47. The method of any of clauses 39-46, further including, prior to receiving the one or more signals from the UE, request the UE to transmit the one or more signals at a specified time, wherein the one or more signals are received at the specified time.
Clause 48. The method of any of clauses 37-44, further including encoding the one or more positioning signals according to the TR precoding by determining one or more channel impulse responses (CIRs) h(t) based on the one or more signals received from the UE, deriving one or more TR filters h(−t)* based on the one or more CIRs, generating one or more TR precoders H(f) based on the one or more TR filters h(−t)*; and encoding the one or more positioning signals based one the generated one or more TR precoders H(f).
Clause 49. A base station, including:
means for receiving a request from a user equipment (UE) for the transmission of one or more positioning signals from the base station, the request one of a request for the base station to transmit the one or more positioning signals using a time reversal (TR) precoding or a request for the one or more positioning signals to be transmitted without using the TR precoding;
means for receiving one or more signals from the UE; and
means for transmitting the one or more positioning signals to the UE based at least in part on the received request and the one or more received signals.
Clause 50. The base station of clause 49, wherein the one or more positioning signals are encoded according to the TR precoding.
Clause 51. The method of any of clauses 49-50, wherein the one or more received signals indicate channel state information (CSI) derived from one or more CSI reference signals (CSI-RS).
Clause 52. The method of any of clauses 49-51, further including means for encoding the one or more positioning signals according to the TR precoding by determining one or more channel impulse responses (CIRs) h(t) based on the one or more signals received from the UE, deriving one or more TR filters h(−t)* based on the one or more CIRs, generating one or more TR precoders H(f) based on the one or more TR filters h(−t)*; and encoding the one or more positioning signals based one the generated one or more TR precoders H(f).
Clause 53. A location server, including:
a transceiver;
a memory; and
a processor communicatively coupled to the transceiver and the memory, the processor configured to:
request transmission of one or more positioning signals from a base station to a user equipment (UE), the request one of a request for the base station to transmit the one or more positioning signals using a time reversal (TR) precoding or a request for the one or more positioning signals to be transmitted without using the TR precoding;
receive one or more signals from the base station, the one or more signals associated with channel state information (CSI) from the UE; and
transmit an indication to the base station, the indication associated with the TR precoding.
Clause 54. The location server of clause 53, wherein transmitting the indication includes signaling the TR precoding the base station is to use when transmitting the one or more positioning signals.
Clause 55. The location server of any of clauses 53-54, wherein transmitting the indication includes indicating that the base station is to select the TR precoding to use when transmitting the one or more positioning signals.
Clause 56. The location server of any of clauses 53-55, further including receiving, from the base station, a beam pattern associated with the TR precoding and sending the received beam pattern to the UE.
Clause 57. A method for positioning in a wireless network, the method performed by a location server and including:
requesting transmission of one or more positioning signals from a base station to a user equipment (UE), the request one of a request for the base station to transmit the one or more positioning signals using a time reversal (TR) precoding or a request for the one or more positioning signals to be transmitted without using the TR precoding;
receiving one or more signals from the base station, the one or more signals associated with channel state information (CSI) from the UE; and
transmitting an indication to the base station, the indication associated with the TR precoding.
Clause 58. The method of clause 57, wherein transmitting the indication includes signaling the TR precoding the base station is to use when transmitting the one or more positioning signals.
Clause 59. The method of any of clauses 57-58, wherein transmitting the indication includes indicating that the base station is to select the TR precoding to use when transmitting the one or more positioning signals.
Clause 60. The method of clause 59, further including receiving, from the base station, a beam pattern associated with the TR precoding and sending the received beam pattern to the UE.
Clause 61. A location server, including:
means for requesting transmission of one or more positioning signals from a base station to a user equipment (UE), the request one of a request for the base station to transmit the one or more positioning signals using a time reversal (TR) precoding or a request for the one or more positioning signals to be transmitted without using the TR precoding;
means for receiving one or more signals from the base station, the one or more signals associated with channel state information (CSI) from the UE; and
means for transmitting an indication to the base station, the indication associated with the TR precoding.
Clause 62. The location server of clause 61, wherein transmitting the indication includes signaling the TR precoding the base station is to use when transmitting the one or more positioning signals.
Clause 63. The location server of any of clauses 61-62, wherein transmitting the indication includes indicating that the base station is to select the TR precoding to use when transmitting the one or more positioning signals.
Clause 64. The location server of clause 63, further including receiving, from the base station, a beam pattern associated with the TR precoding and sending the received beam pattern to the UE.

1. A user equipment (UE), comprising:
a transceiver;
a memory; and
a processor communicatively coupled to the transceiver and the memory,
the processor configured to:
transmit a request for the transmission of one or more positioning signals from a base station, the request associated with a time reversal (TR) precoding;
transmit one or more signals to the base station; and
receive, from the base station, the one or more positioning signals based at least in part on the transmitted request and the one or more transmitted signals.

2. The UE of claim 1,
wherein the request is a request for the base station to transmit the one or more positioning signals using the TR precoding, and wherein the one or more received positioning signals are encoded according to the TR precoding.

3. The UE of claim 2, wherein the one or more positioning signals comprise one or more positioning reference signals (PRS).

4. The UE of claim 2, wherein the one or more transmitted signals comprise one or more sounding reference signals (SRS).

5. The UE of claim 4, wherein the one or more SRS are transmitted over a frequency band at least partially overlapping with a frequency band over which the one or more positioning signals are received.

6. The UE of claim 2, wherein the one or more transmitted signals are based at least in part on channel state information (CSI) measured from a previously received positioning signal received from the base station.

7. The UE of claim 2, wherein the one or more transmitted signals indicate channel state information (CSI) derived from one or more CSI reference signals (CSI-RS) received by the UE.

8. The UE of claim 7, wherein the one or more transmitted signals include CSI comprising one or more of a channel impulse response, a channel frequency response, a partial channel impulse response, a shortened channel impulse response, a power delay profile (PDP), a wideband channel frequency response, a narrowband frequency response, or a doppler shift measurement.

9. The UE of claim 2, wherein the processor is further configured to, prior to requesting the transmission of the one or more positioning signals, indicate to a location server whether or not the UE supports transmission of CSI feedback or transmission of one or more SRS signals associated with the reception of the one or more positioning signals.

10. The UE of claim 2, wherein the processor is further configured to, prior to transmitting the one or more signals to the base station, receive a request to transmit the one or more signals at a specified time, wherein the one or more signals are transmitted at the specified time.

11. The UE of claim 1, wherein the request is a request for the one or more positioning signals to be transmitted without using the TR precoding.

12. The UE of claim 11, wherein the request is transmitted in response to an insufficient channel reciprocity between the UE and the base station.

13. A method for positioning in a wireless network, the method performed by a user equipment (UE) and comprising:
transmitting a request for the transmission of one or more positioning signals from a base station, the request associated with a time reversal (TR) precoding;
transmitting one or more signals to the base station; and
receiving, from the base station, the one or more positioning signals based at least in part on the transmitted request and the one or more transmitted signals.

14. The method of claim 13, wherein the request is a request for the base station to transmit the one or more positioning signals using the TR precoding, and wherein the one or more positioning signals are encoded according to the TR precoding.

15. The method of claim 14, wherein the one or more positioning signals comprise one or more positioning reference signals (PRS).

16. The method of claim 14, wherein the one or more transmitted signals comprise one or more sounding reference signals (SRS).

17. The method of claim 16, wherein the one or more SRS are transmitted over a frequency band at least partially overlapping with a frequency band over which the one or more positioning signals are received.

18. The method of claim 14, wherein the one or more transmitted signals are based at least in part on channel state information (CSI) measured from a previously received positioning signal received from the base station.

19. The method of claim 14, wherein the one or more transmitted signals indicate channel state information (CSI) derived from one or more CSI reference signals (CSI-RS) received by the UE.

20. The method of claim 19, wherein the one or more transmitted signals include CSI comprising one or more of a channel impulse response, a channel frequency response, a partial channel impulse response, a shortened channel impulse response, a power delay profile (PDP), a wideband channel frequency response, a narrowband frequency response, or a doppler shift measurement.

21.-28. (canceled)

29. A base station, comprising:
a transceiver;
a memory; and
a processor communicatively coupled to the transceiver and the memory,
the processor configured to:
receive a request for the transmission of one or more positioning signals from the base station to a user equipment (UE), the request associated with a time reversal (TR) precoding;
receive one or more signals from the UE; and
transmit the one or more positioning signals to the UE based at least in part on the received request and the one or more received signals.

30. The base station of claim 29, wherein the request is a request for the base station to transmit the one or more positioning signals using the TR precoding, and wherein the one or more positioning signals are encoded according to the TR precoding.

31. The base station of claim 30, wherein the one or more positioning signals comprise one or more positioning reference signals (PRS).

32. The base station of claim 30, wherein the one or more received signals comprise one or more sounding reference signals (SRS).

33. The base station of claim 32, wherein the one or more SRS are received over a frequency band at least partially overlapping with a frequency band over which the one or more positioning signals are transmitted.

34. The base station of claim 30, wherein the one or more received signals are based at least in part on channel state information (CSI) measured from a previous positioning signal transmitted by the base station.

35. The base station of claim 30, wherein the one or more received signals indicate channel state information (CSI) derived from one or more CSI reference signals (CSI-RS).

36. The base station of claim 35, wherein the one or more received signals include CSI comprising one or more of a channel impulse response, a channel frequency response, a partial channel impulse response, a shortened channel impulse response, a power delay profile (PDP), a wideband channel frequency response, a narrowband frequency response, or a doppler shift measurement.

37. The base station of claim 30, wherein the processor is further configured to, prior to receiving the one or more signals from the UE, request the UE to transmit the one or more signals at a specified time, wherein the one or more signals are received at the specified time.

38. The base station of claim 29, wherein the processor is further configured to encode the one or more positioning signals according to the TR precoding by determining one or more channel impulse responses (CIRs) h(t) based on the one or more signals received from the UE, deriving one or more TR filters h(−t)* based on the one or more CIRs, generating one or more TR precoders H(f) based on the one or more TR filters h(−t)*; and encoding the one or more positioning signals based one the generated one or more TR precoders H(f).

39. A method for positioning in a wireless network, the method performed by a base station and comprising:
receiving a request from a user equipment (UE) for the transmission of one or more positioning signals from the base station, the request associated with a time reversal (TR) precoding;
receiving one or more signals from the UE; and
transmitting the one or more positioning signals to the UE based at least in part on the received request and the one or more received signals.

40.-52. (canceled)

53. A location server, comprising:
a transceiver;
a memory; and
a processor communicatively coupled to the transceiver and the memory,
the processor configured to:
request transmission of one or more positioning signals from a base station to a user equipment (UE), the one or more positioning signals associated with a time reversal (TR) precoding;
receive one or more signals from the base station, the one or more signals associated with channel state information (CSI) from the UE; and
transmit an indication to the base station, the indication associated with the TR precoding.

54. The location server of claim 53, wherein transmitting the indication comprises signaling the TR precoding the base station is to use when transmitting the one or more positioning signals.

55. The location server of claim 53, wherein transmitting the indication comprises indicating that the base station is to select the TR precoding to use when transmitting the one or more positioning signals.

56. The location server of claim 55, further comprising receiving, from the base station, a beam pattern associated with the TR precoding and sending the received beam pattern to the UE.

57.-64. (canceled)
